(19) United States
(12) Patent Application Publication
(10) Pub. No.: US 2021/0081748 A1
(43) Pub. Date: Mar. 18, 2021

(54) PROXIMITY AND DUAL INTERFACE METAL CARDS AND METHODS OF MAKING CARD BODIES WITH TWO METAL LAYERS

(71) Applicant: Federal Card Services, LLC, Cincinnati, OH (US)

(72) Inventor: David Finn, Fussen Weissensee (DE)

(21) Appl. No.: 16/995,849

(22) Filed: Aug. 18, 2020

Related U.S. Application Data
(63) Continuation-in-part of application No. 16/991,136, filed on Aug. 12, 2020.
(60) Provisional application No. 63/053,559, filed on Jul. 17, 2020.
(60) Provisional application No. 63/040,544, filed on Jun. 18, 2020.
(60) Provisional application No. 63/040,033, filed on Jun. 17, 2020.
(60) Provisional application No. 63/035,670, filed on Jun. 5, 2020.
(60) Provisional application No. 63/034,965, filed on Jun. 4, 2020.
(60) Provisional application No. 63/031,571, filed on May 29, 2020.
(60) Provisional application No. 63/014,142, filed on Apr. 23, 2020.
(60) Provisional application No. 62/986,612, filed on Mar. 6, 2020.
(60) Provisional application No. 62/981,040, filed on Feb. 25, 2020.
(60) Provisional application No. 62/979,422, filed on Feb. 21, 2020.
(60) Provisional application No. 62/978,826, filed on Feb. 20, 2020.
(60) Provisional application No. 62/971,927, filed on Feb. 8, 2020.
(60) Provisional application No. 62/969,034, filed on Feb. 1, 2020.
(60) Provisional application No. 62/960,178, filed on Jan. 13, 2020.
(60) Provisional application No. 62/936,519, filed on Nov. 17, 2019.
(60) Provisional application No. 62/912,701, filed on Oct. 9, 2019.
(60) Provisional application No. 62/894,976, filed on Sep. 3, 2019.
(60) Provisional application No. 62/891,433, filed on Aug. 26, 2019.
(60) Provisional application No. 62/891,308, filed on Aug. 24, 2019.
(60) Provisional application No. 62/889,555, filed on Aug. 20, 2019.
(60) Provisional application No. 62/889,055, filed on Aug. 20, 2019.
(60) Provisional application No. 62/888,539, filed on Aug. 18, 2019.

(51) Int. Cl. G06K 19/077

(52) U.S. Cl. CPC G06K 19/07794; G06K 19/0775; G06K 19/07722; G06K 19/07781; G06K 19/07775

(57) ABSTRACT

Proximity cards or contactless smartcards manufactured by folding a metal layer along one or two fold lines to form a metal card body (MCB) having the dimensions of a standard ID-1 smartcard. An antenna structure (AS) on a flexible or rigid circuit sandwiched powering an RFID chip may be disposed between the folded metal layer or metal layers. A smartcard (SC) characterized by a booster antenna (BA) arranged on a rear plastic layer laminated to a front metal layer (ML) having a slit (S). A sense coil (SeC) component may be arranged around the slit, and may overlap the slit in a zigzag fashion or the like. The sense coil may have a loop, spiral or helix shape. The booster antenna may form a closed loop circuit or an open loop circuit.

### CROSS-REFERENCES TO RELATED APPLICATIONS

Priority (filing date benefit) is claimed from the following, incorporated by reference herein:

This application is a continuation-in-part of U.S. Ser. No. 16/991,136 filed 12 Aug. 2020

This application is:
a nonprovisional of 63/053,559 filed 17 Jul. 2020
a nonprovisional of 63/040,544 filed 18 Jun. 2020
a nonprovisional of 63/040,033 filed 17 Jun. 2020
a nonprovisional of 63/035,670 filed 5 Jun. 2020
a nonprovisional of 63/034,965 filed 4 Jun. 2020
a nonprovisional of 63/031,571 filed 29 May 2020
a nonprovisional of 63/014,142 filed 23 Apr. 2020
a nonprovisional of 62/986,612 filed 6 Mar. 2020
a nonprovisional of 62/981,040 filed 25 Feb. 2020
a nonprovisional of 62/979,422 filed 21 Feb. 2020
a nonprovisional of 62/978,826 filed 20 Feb. 2020
a nonprovisional of 62/971,927 filed 8 Feb. 2020
a nonprovisional of 62/969,034 filed 1 Feb. 2020
a nonprovisional of 62/960,178 filed 13 Jan. 2020
a nonprovisional of 62/936,519 filed 17 Nov. 2019
a nonprovisional of 62/912,701 filed 9 Oct. 2019
a nonprovisional of 62/894,976 filed 3 Sep. 2019
a nonprovisional of 62/891,433 filed 26 Aug. 2019
a nonprovisional of 62/891,308 filed 24 Aug. 2019
a nonprovisional of 62/889,555 filed 20 Aug. 2019
a nonprovisional of 62/889,055 filed 20 Aug. 2019
a nonprovisional of 62/888,539 filed 18 Aug. 2019

### TECHNICAL FIELD

The invention relates to the field of RFID-enabled metal transaction cards and, more particularly, to contactless metal cards (aka proximity metal cards), and contact and contactless metal cards (aka dual interface (DI) metal cards) having a booster antenna (BA) with an antenna structure (AS) overlying or fitting into a slit (S) in a metal card body (MCB) or a coupling loop structure (CLS) with antenna structures on a flexible circuit (FC) overlapping a module antenna (MA) and overlying or fitting into a slit (S) in a metal card body (MCB).

Some of the disclosure(s) herein may relate to an inductive coupling chip module or a flexible circuit (FC) with a sense coil (SeC) and a coupling loop structure (CLS) with an antenna structure(s) (AS), embeddable in a metal housing, casing, foldable metal structure or a laminated metal card stack-up construction.

Some of the disclosure(s) herein may also relate to Coil on Chip (CoC), Transponder Chip Module (TCM), Inductive Coupling Chip Modules (ICM) or Coil on Module (CoM) with and without contact pads. Chip modules without contact pads may be referred to as RFID chip modules or RFID flexible circuits with a Module Antenna (MA) connected to an RFID chip. RFID terminology also includes NFC or NFC/CTLS protocols.

The disclosure may relate broadly to RFID devices including electronic identification (eID) cards, employee ID cards, secure credentials, access control cards and security badges capable of operating in a “contactless” mode, meeting ISO 14443B or NFC/ISO 15693 for contactless communication.

The disclosure may further relate to identification cards which may combine 13.56 MHz contactless read/write smartcard technology and 125 kHz proximity technology on a single card with the ability to add a Wiegand strip, magnetic stripe, barcode, and anti-counterfeiting features including custom artwork or a photo identification directly on the card credential. Some of the disclosure(s) herein may relate to electronic identification cards and financial payment cards having a contact and a contactless interface.

The techniques disclosed herein may also be applicable to RFID devices including “non-secure smartcards and tags” such as contactless cards in the form of identification tags worn by military personnel, medic-alert tags, loyalty cards, asset tags, event passes, hotel keycards, small form factor tags, key-fobs, data carriers and the like operating in close proximity with a contactless reader.

### BACKGROUND

Passive radio frequency identification (RFID) cards come in two form factors: clamshell cards and ISO compliant laminated cards similar to financial payment cards. The cards may have a slot punched for attachment to a lanyard or keychain via a standard clip aperture. The cards may be programmed and printed with custom artwork.

In recent times, the operating frequency of proximity cards has shifted from 125 kHz to 13.56 MHz read/write contactless technology providing high-speed, reliable communication with high data integrity.

13.56 MHz read/write contactless smartcard technology can be used for diverse applications such as access control, time and attendance, network log-on security, biometric verification, cashless vending, public transportation, airline ticketing and customer loyalty programs.

Clamshell cards or badges are among the most popular contactless identification card form factor in access control or time and attendance applications in corporate, government and educational environments.

Clamshell cards have the following features:
Typical Dimensions: 3.4×2.1×0.07 inches (85.7×53.9×1.73 mm)
Housing Material: ABS (hard shell); PVC cover foil
Card Body Color: White
Operating Temperature: +14° to +122° F. (−10° to +50° C.)
Optional Features: Dual-sided printing; encoding; embossed logo

The ISO 7810 compliant cards are laminated PVC cards that may be printed on both sides, using most standard direct-image and thermal transfer card printers. The ISO model may support vertical or horizontal slot punching. A magnetic stripe with high coercivity (4,000 Oersted—unencoded) may provide an added swipe card capability.

ISO cards have the following features:
Typical Dimensions: 2.125″ Width×3.370″ Height×0.030″ Thickness (5.4 cm W×8.6 cm H×0.076 cm T)
Housing Material: PVC
Card Body Color: Off White
Operating Temperature: −95°-140° F. (−35°-50° C.)
Optional Features: Direct Print/Thermal Transfer

U.S. Pat. No. 6,214,155 (2001 Apr. 10; Leighton) discloses a radio frequency identification card and hot lamination process for the manufacture of radio frequency identification cards. A plastic card, such as a radio frequency identification card, including at least one electronic element embedded therein and a hot lamination process for the manufacture of radio frequency identification cards and other plastic cards including a micro-chip embedded therein. The process results in a card having an overall thickness in the range of 0.028 inches to 0.032 inches with a surface suitable for receiving dye sublimation printing. The variation in card thickness across the surface is less than 0.0005 inches. A card manufactured also complies with all industry standards and specifications. Also, the hot lamination process results in an aesthetically pleasing card.

A dual interface (DI or DIF) smartcard (or smart card (SC)), as an example of an RFID device, may generally comprise:
a transponder chip module (TCM),
a card body (CB) or inlay having layers of plastic or metal, or combinations thereof, and
a booster antenna (BA) or coupling frame (CF).

The transponder chip module (TCM), which may be referred to as an inductive coupling chip module (ICM), or RFID module may generally comprise:
a module tape (MT) or chip carrier tape (CCT), more generally, simply a “substrate”;
a contact pad array (CPA) comprising 6 or 8 contact pads (CP, or “ISO pads”) disposed on a “face up side” or “contact side” (or surface) of the module tape (MT), for interfacing with a contact reader in a contact mode (ISO 7816);
an RFID chip (CM, IC) which may be a bare, unpackaged silicon die or a chip module (a die with leadframe, interposer, carrier or the like) disposed on a “face down side” or “bond side” or “chip side” (or surface) of the module tape (MT), whereby the silicon die may be wire bonded or flip chipped to the module tape (MT, CCT);
a module antenna (MA) or antenna structure (AS) disposed on the face down side of the module tape (MT, CCT) for implementing a contactless interface, such as ISO 14443 and NFC/ISO 15693 with a contactless reader or other RFID device.

The module antenna (MA) of the transponder chip module (TCM) may couple with an in-card booster antenna (BA) or coupling frame (CF).

The module antenna (MA) may be a planar antenna (PA) which is etched from a foil (which may be supported by the module tape (MT, CCT) to have a spiral track having a number of turns. The track (hence turns) may measure approximately 70 μm in width. Spaces between adjacent turns of the spiral track may measure approximately 75 μm (chemical etching) or 25 μm (laser etching) in width. Etching may be performed by chemical means, or laser ablation, or a combination thereof.

When operating in a contactless mode, a passive transponder chip module (TCM) may be powered by RF from an external RFID reader and may also communicate by RF with the external RFID reader.

In the main, hereinafter, RFID devices such as proximity cards, dual interface smartcards, and objects incorporating a transponder chip module may be passive devices, not having a battery and harvesting power from an external contactless reader (ISO 14443). However, some of the teachings presented herein may find applicability with cards having self-contained power sources, such as small batteries or supercapacitors.

In addition, some of the teachings presented herein may be applicable to UHF proximity cards made of metal.

US 2020/0034578 (2020 Jan. 30; Finn et al.) discloses SMARTCARD WITH DISPLAY AND ENERGY HARVESTING. A wireless connection may be established between two electronic modules (M1, M2) disposed in module openings (MO-1, MO-2) of a smartcard so that the two modules may communicate (signals, data) with each other. The connection may be implemented by a booster antenna (BA) having two coupler coils (CC-1, CC-2) disposed close to the two modules, and connected with one another. The booster antenna may also harvest energy from an external device such as a card reader, POS terminal, or a smartphone. A coupling antenna (CPA) may have only the two coupler coils connected with one another, without the peripheral card antenna (CA) component of a conventional booster antenna. A module may be disposed in only one of the two module openings. As disclosed therein:

FIG. 2 is a block diagram of a smartcard having a display.

FIG. 3 is a diagram of a booster antenna having two coupler coils.

FIG. 4A is a diagram of a smartcard having a coupling frame with two openings, for respective two modules.

FIG. 4B is a diagram of a smartcard having two coupling frames, each with an opening for a module.

FIG. 4C is a diagram of a smartcard having a coupling frame with two openings, one (or both) of which may be populated with a module.

FIG. 4C shows a metal layer (ML) with two module openings (MO-1, MO-2) and respective two slits (S1, S2). Compare FIG. 4A.

FIG. 4C additionally shows a coupling antenna (CPA) which may similar to the booster antenna (BA) shown in FIG. 3, but without the peripheral card antenna (CA) component. In other words, the coupling antenna (CPA) is shown having two coupler coils (CC-1) and (CC-2) overlapping, within or in close proximity to respective two module openings (MO-1, MO-2) of the card body (CB) and coupling frame (CF). The two coupler coils (CC-1, CC-2) may both have free ends (•). Alternatively, the ends of the two coupler coils could be connected with one another, as illustrated by the dashed line.

### Some US Patents and Publications

The following US patents and patent application publications are referenced, some of which may relate to “RFID Slit Technology”:
U.S. Pat. No. 10,599,972 Smartcard constructions and methods
U.S. Pat. No. 10,552,722 Smartcard with coupling frame antenna
U.S. Pat. No. 10,518,518 Smartcards with metal layers and methods of manufacture
U.S. Pat. No. 10,248,902 Coupling frames for RFID devices
U.S. Pat. No. 10,193,211 Smartcards, RFID devices, wearables and methods
U.S. Pat. No. 9,960,476 Smartcard constructions
U.S. Pat. No. 9,836,684 Smartcards, payment objects and methods
U.S. Pat. No. 9,812,782 Coupling frames for RFID devices
U.S. Pat. No. 9,798,968 Smartcard with coupling frame and method of increasing activation distance
U.S. Pat. No. 9,697,459 Passive smartcards, metal cards, payment objects
U.S. Pat. No. 9,634,391 RFID transponder chip modules
U.S. Pat. No. 9,622,359 RFID transponder chip modules
U.S. Pat. No. 9,489,613 RFID transponder chip modules with a band of the antenna extending inward
U.S. Pat. No. 9,475,086 Smartcard with coupling frame and method of increasing activation distance
U.S. Pat. No. 9,390,364 Transponder chip module with coupling frame on a common substrate
2020/0151534 Smartcards with metal layers and methods of manufacture
2020/0050914 Connection bridges for dual interface transponder chip modules
2020/0034578 Smartcard with display and energy harvesting
2020/0005114 Dual interface metal hybrid smartcard
2019/0392283 RFID transponder chip modules, elements thereof, and methods
2019/0197386 Contactless smartcards with multiple coupling frames
2019/0171923 Metallized smartcard constructions and methods
2019/0114526 Smartcard constructions and methods
2018/0341847 Smartcard with coupling frame antenna
2018/0341846 Contactless metal card construction
2018/0339503 Smartcards with metal layers and methods of manufacture

Some Additional US Patents and Publications
U.S. Pat. No. 10,583,683 (10 Mar. 2020; Ridenour et al.). See also 2020/0164675.
U.S. Pat. No. 10,534,990 (14 Jan. 2020; CompoSecure; Herslow et al.)
U.S. Pat. No. 10,445,636 (15 Oct. 2019; Giesecke & Devrient; Virostek et al.)
U.S. Pat. No. 10,395,164 (27 Aug. 2019; Fingerprint Cards; Lundberg et al.)
U.S. Pat. No. 10,325,135 (18 Jun. 2019; Fingerprint Cards; Andersen et al.)
U.S. Pat. No. 10,318,859 (11 Jun. 2019; CompoSecure; Lowe, et al.)
U.S. Pat. No. 10,289,944 (14 May 2019; CompoSecure; Herslow et al.)
U.S. Pat. No. 10,275,703 (30 Apr. 2019; CompoSecure; Herslow et al.)
U.S. Pat. No. 10,140,569 (27 Nov. 2018; Kim et al.)
U.S. Pat. No. 10,089,570 (2 Oct. 2018; CompoSecure; Herslow et al.)
U.S. Pat. No. 10,032,169 (2018 Jul. 24; Essebag et al.; Ellipse World)
U.S. Pat. No. 9,898,699 (20 Feb. 2018; CompoSecure; Herslow et al.)
U.S. Pat. No. 9,892,405 (13 Feb. 2018; Cardlab; Olson et al.)
U.S. Pat. No. 9,760,816 (12 Sep. 2017; Williams et al.). See also U.S. Pat. No. 9,836,687.
U.S. Pat. No. 9,727,759 (2017 Aug. 8; Essebag et al.; Ellipse World)
U.S. Pat. No. 9,721,200 (1 Aug. 2017; Herslow et al.)
U.S. Pat. No. 9,564,678 (7 Feb. 2017; Kato et al.). See also U.S. Pat. Nos. 8,976,075 and 9,203,157.
U.S. Pat. No. 9,390,366 (12 Jul. 2016; Herslow et al.)
U.S. Pat. No. 9,299,020 (29 Mar. 2016; TheCard; Zimmerman et al.)
U.S. Pat. No. 9,024,763 (5 May 2015; Hamedani Soheil)
U.S. Pat. No. 8,931,691 (2015 Jan. 13; Manessis et al.; VISA)
U.S. Pat. No. 8,777,116 (2014 Jun. 15; Lin; Smartdisplayer)
U.S. Pat. No. 8,737,915 (27 May 2014; J. H. Tonnjes E.A.S.T.; Beenken)
U.S. Pat. No. 8,608,082 (17 Dec. 2013; La Garrec et al.; Oberthur Technologies, aka IDEMIA)
U.S. Pat. No. 8,490,872 (2013 Jul. 23 Kim)
U.S. Pat. No. 8,448,872 (2013 May 28; Droz; Nagra ID)
U.S. Pat. No. 8,393,547 (12 Mar. 2013; Perfect Plastic Printing; Kiekhaefer et al.)
U.S. Pat. No. 8,186,582 (29 May 2012; American Express; Varga et al.). See also U.S. Pat. No. 8,523,062
U.S. Pat. No. 7,306,163 (11 Dec. 2007; IBM; Scholz et al.)
U.S. Pat. No. 6,491,229 (10 Dec. 2002; NJC Innovations; Berney)
U.S. Pat. No. 6,452,563 (17 Sep. 2002; Gemplus aka Gemalto; Porte)
2019/0384261 (19 Dec. 2019; Kona I; Nam et al.)
2019/0311235 (2019 Oct. 10; Sexl et al.; (Giesecke & Devrient)
2019/0311236 (2019 Oct. 10; Sexl et al.; (Giesecke & Devrient)
2019/0291316 (2019 Sep. 26; Lowe; now U.S. Pat. No. 10,583,594).
2019/0286961 (2019 Sep. 19; Lowe)
2019/0251322 (15 Aug. 2019; IDEX ASA; Slogedal et al.)
2019/0251411 (2019 Aug. 15; Gire et al.; Paragon ID)
2019/0236434 (1 Aug. 2019; CompoSecure; Lowe)
2019/0160717 (2019 May 30; Lowe)
2019/0156994 (23 May 2019; X-Card Holdings; Cox)
2019/0102662 (4 Apr. 2019; Zwipe; Snell et al.)
2019/0073578 (7 Mar. 2019; Lowe et al.)
2019/0050706 (14 Feb. 2019; Lowe) now U.S. Pat. No. 10,406,734
2018/0005064 (4 Jan. 2018; Next Biometrics; Vogel et al.)
2016/0148194 (2016 May 26; Guillad et al.; Nagraid)
2015/0206047 (23 Jul. 2015; Herslow)
2014/0279555 (2014 Sep. 18; Guillaud; Nagraid)
2014/0231503 (21 Aug. 2014; Smart Co.; Kunitaka)
2013/0126622 (23 May 2013; Finn)
2012/0112971 (10 May 2012; Takeyama et al.;)
2011/0181486 (28 Jul. 2011; Kato;)

### Some Non-Patent Literature and Non-US Patents and Publications:

Chen, S. L., Kuo, S. K. and Lin C. T. (2009), “A metallic RFID tag design for steel-bar and wire-rod management application in the steel industry” (Progress in Electromagnetics Research, PIER Vol. 91: pp. 195-212.)
EP 2372840 (25 Sep. 2013; Hashimoto; Panasonic)
CN 205158409U (13 Apr. 2016)
KR 10-1754985 (30 Jun. 2017; Kim et al.; Aichi CK Corporation aka ICK)
PCT/US2019/020919 (12 Sep. 2019; Cox; X-Card Holding)
WO 2017/090891 (1 Jun. 2017; Yoon et al.; Biosmart)

| | |
|---|---|
| D665,851 | Metal card |
| 5,215,792 | Informative card made of sheet metal |
| 5,834,127 | Informative card made of sheet metal |
| 7,523,870 | RFID card retention assembly |
| 8,317,108 | Chip card with dual communication interface |
| 8,393,547 | RF proximity financial transaction card having |
| | metallic foil layer(s) |
| 9,070,979 | Booster antenna for a chip arrangement, contactless |
| | smartcard module arrangement and chip arrangement |
| 9,390,366 | Metal smartcard with dual interface capability |
| 9,633,303 | Smartcard module arrangement |
| 10,032,099 | Weighted transaction card |
| 10,157,848 | Chip card module arrangement, chip card arrangement |
| | and method for producing a chip card arrangement |
| 2013/0168454 | Metal payment card and method of manufacturing |
| | the same |

### Some Definitions

Some of the following terms may be used or referred to, herein. Some may relate to background or general knowledge, others may relate to the invention(s) disclosed herein.

### Eddy Currents

Eddy currents are induced electrical currents that flow in a circular path. In other words, they are closed loops of induced current circulating in planes perpendicular to the magnetic flux. Eddy currents concentrate near the surface adjacent to the excitation coil of the contactless reader generating the electromagnetic field, and their strength decreases with distance from the transmitter coil. Eddy current density decreases exponentially with depth. This phenomenon is known as the skin effect. The depth that eddy currents penetrate into a metal object is affected by the frequency of the excitation current and the electrical conductivity and magnetic permeability of the metal.

### Skin Depth

Skin effect is the tendency of an alternating electric current (AC) to become distributed within a conductor such that the current density is largest near the surface of the conductor, and decreases with greater depths in the conductor. The electric current flows mainly at the “skin” of the conductor, between the outer surface and a level called the skin depth. The skin effect causes the effective resistance of the conductor to increase at higher frequencies where the skin depth is smaller, thus reducing the effective cross-section of the conductor. The skin effect is due to opposing eddy currents induced by the changing magnetic field resulting from the alternating current.

### Eddy Currents and a Slit in a Metal Layer or Metal Card Body

A discontinuity interrupts or alters the amplitude and pattern of the eddy currents which result from the induced electromagnetic field generated by a contactless point of sale terminal. The eddy current density is highest near the surface of the metal layer (ML) and decreases exponentially with depth.

### RFID Slit Technology

Providing a metal layer in a stack-up of a card body, or an entire metal card body, to have a module opening for receiving a transponder chip module (TCM) and a slit (S) to improve contactless (RF) interface with the card—in other words, a “coupling frame”—may be described in greater detail in U.S. Pat. Nos. 9,475,086, 9,798,968, and in some other patents that may be mentioned herein. In some cases, a coupling frame may be formed from a metal layer or metal card body having a slit, without having a module opening. A typical slit may have a width of approximately 100 μm. As may be used herein, a “micro-slit” refers to a slit having a smaller width, such as approximately 50 μm, or less.

“RFID Slit Technology” refers to modifying a metal layer (ML) or a metal card body (MCB) into a so-called “antenna circuit” by providing a discontinuity in the form of a slit, slot or gap in the metal layer (ML) or metal card body (MCB) which extends from a peripheral edge to an inner area or opening of the layer or card body. The concentration of surface current at the inner area or opening can be picked up by another antenna (such as a module antenna) or antenna circuit by means of inductive coupling which can drive an electronic circuit such as an RFID chip attached directly or indirectly thereto. The slit may be ultra-fine (typically less than 50 μm or less than 100 μm), cut entirely through the metal with a UV laser, with the debris from the plume removed by ultrasonic or plasma cleaning. Without a cleaning step after lasing, the contamination may lead to shorting across the slit. In addition, the slit may be filled with a dielectric to avoid such shorting during flexing of the metal forming the transaction card. The laser-cut slit may be further reinforced with the same filler such as a resin, epoxy, mold material, repair liquid or sealant applied and allowed to cure to a hardened state or flexible state. The filler may be dispensed or injection molded. The term “slit technology” may also refer to a “coupling frame” with the aforementioned slit, or to a smartcard embodying the slit technology or having a coupling frame incorporated therein.

### Module Antenna (MA)

The term “module antenna” (MA) may refer to an antenna structure (AS) located on the face-down-side of a transponder chip module (TCM) or dual interface chip module (DI chip module) for inductive coupling with an in-card booster antenna (BA) or coupling frame (CF). The antenna structure (AS) is usually rectangular in shape with dimensions confined to the size of the module package having 6 or 8 contact pads on the face-up-side. The termination ends of the antenna structure (AS) with multiple windings (13 to 15 turns) based on a frequency of interest (e.g. 13.56 MHz) are bonded to the connection pads (L_{A} and L_{B}) on the RFID chip. In the case of a coupling frame (CF) smartcard such as a dual interface metal core transaction card, the module antenna (MA) overlaps the coupling frame (CF) or metal layer(s) within the card body at the area of the module opening to accept the transponder chip module (TCM).

### Coupling Loop Antenna (CLA)

The term “coupling loop antenna” (CLA) may refer to an antenna structure (AS) which couples to a module antenna (MA) in a transponder chip module (TCM). The windings or traces of the coupling loop antenna (CLA) may intertwine those windings of the module antenna (MA), or the windings or traces of the coupling loop antenna (CLA) may couple closely with the windings of the module antenna (MA) similar in function to a primary and secondary coil of a transformer. The termination ends of a coupling loop antenna (CLA) may be connected to termination points (TPs) across a discontinuity in a metal layer (ML) or metal card body (MCB) acting as a coupling frame (CF).

### Coupling Frame Antenna (CFA)

The term “coupling frame antenna” (CFA) may refer to a metal layer or metal card body with a discontinuity may be represented by card size planar antenna having a single turn, with the width of the antenna track significantly greater than the skin depth at the frequency of interest.

### Sense Coil (SeC), Patch Antenna (PA) and Pick-Up Coil (PuC)

The terms “Sense Coil” (SeC), “Patch Antenna” (PA) and “Pick-up Coil” (PuC) may refer to various types of coils or antennas used to capture surface current by means of inductive coupling at the edge of a metal layer (ML) or metal card body (MCB) or around a discontinuity in a metal layer (ML) or metal card body (MCB) when such conductive surfaces are exposed to an electromagnetic field. The coils or antennas may be wire wound, chemically etched or laser etched, and positioned at very close proximity to a discontinuity in a metal layer, at the interface between a conductive and non-conductive surface, or at the edge of a metal layer.

### Antenna Cell (AC)

The term “antenna cell” (AC) may refer to an antenna structure (AS) such as sense coil (SeC), patch antenna (PA) or pick-up coil (PuC) on a flexible circuit (FC) driving an electronic component such as a fingerprint sensor or a dynamic display. A plurality of antenna cells (ACs) at different locations in a metal transaction card may be used to power several electronic components.

### Antenna Probe (AP)

A pick-up antenna in the form of a micro-metal strip (first electrode) may be placed in the middle of a discontinuity to probe eddy current signals from the magnetic flux interaction with the metal layer acting as the coupling frame. The metal layer also acts as the second electrode in the circuit. The metal strip may be replaced by a sense coil with a very fine antenna structure to pick-up the surface currents from within the discontinuity.

### Booster Antenna

A booster antenna (BA) in a smartcard comprises a card antenna (CA) component with multiple turns or windings extending around the periphery edge of the card body (CB), a coupler coil (CC) component at a location for a module antenna (MA) of a transponder chip module (TCM), and an extension antenna (EA) component contributing to the inductance and tuning of the booster antenna (BA). A conventional booster antenna is a wire embedded antenna, ultrasonically scribed into a synthetic layer forming part of the stack-up construction of a dual interface smartcard. The card antenna (CA) on the periphery of the card body (CB) inductively couples with the contactless reader while the coupler coil (CC) inductively couples with the module antenna (MA) driving the RFID chip.

U.S. Pat. No. 9,033,250 (2015 May 19; Finn et al.) discloses a booster antenna (BA) for a smart card comprises a card antenna (CA) component extending around a periphery of a card body (CB), a coupler coil (CC) component at a location for an antenna module (AM), and an extension antenna (EA) contributing to the inductance of the booster antenna (BA).

### Coupling Loop Structure (CLS)

The term “coupling loop structure” may refer to a flexible circuit (FC) with a sense Coil (SeC), patch antenna (PA) or pick-up coil (PuC) for inductive coupling with a discontinuity in a metal layer (coupling frame) to pick-up surface currents and to direct such currents via traces or tracks to an antenna having a frame or spiral shape on the flexible circuit (FC) which further inductively couples in close proximity with the module antenna (MA) of a transponder chip module (TCM).

### Metal Edge & Metal Ledge

For optimum RF performance, the dimensional width of the windings (or width across multiple windings) of a sense coil (SeC), patch antenna (PA) or a pick-up coil (PuC) ought to overlap a metal edge (ME) of a slit, gap or notch in the card body by 50% of the distance across the windings to capture the surface currents at the metal edge (or ledge).

A sense coil (SeC), patch antenna (PA) or a pick-up coil (PuC) (all or which may be referred to as “antennas”, or antenna structures (AS)) may comprise multiple windings (or tracks), and may have a width. For optimum performance, the antenna should overlap a metal edge (ME).

The same principle of overlap may apply to the module antenna (MA) of a transponder chip module (TCM) implanted in a metal containing transaction card. The dimensional width of the windings of the module antenna (MA) ought to overlap a metal ledge (P1) of a stepped cavity forming the module pocket in a card body by 50% of the distance across the windings of the module antenna (MA).

In the case of an antenna structure (AS) which is an antenna probe (AP), which does not overlap a slit or gap, but rather is disposed within the slit or gap, surface currents may be collected when the antenna probe (AP) is between and very close to the metal edges forming the slit or gap. The probe is disposed within the slit, and dimensional fits into the slit being at close proximity to the walls of the slit. As the shape and form of the antennas may change, the dimensional width of the windings may be replaced by the surface area or volume.

### SUMMARY

It is an object of the invention(s), as may be disclosed in various embodiments presented herein, to provide improvements in the manufacturing, performance and/or appearance of smartcards (also known as transaction cards), such as metal transaction cards and, more particularly, to RFID-enabled smartcards (which may be referred to herein simply as “cards”) having at least contactless capability, including dual interface (contactless and contact) smartcards, including cards having a metal layer in the stackup of their card body, and including cards having a card body which is substantially entirely formed of metal (i.e., a metal card body).

The invention(s) disclosed herein make use of the surface eddy currents which flow along the perimeter edge of a conductive surface such as a metal card body (MCB) which has been exposed to electromagnetic waves, generated by a contactless reader or terminal. The intensity of such eddy currents at the frequency of interest is a maximum along the skin depth of the metal at its perimeter edge. The skin depth of copper, for example, at 13.56 MHz is approximately 18 μm.

The distance in which the slit (S) or notch (N) needs to extend from the perimeter edge across the metal layer (ML) or metal card body (MCB), concentrating the surface current density, needs to be a substantial multiple of the skin depth distance to facilitate the diversion of current. Notably, the slit (S) or notch (N) passes entirely through the metal layer (ML, MCB), and the shape of the slit or notch can be straight, curved, u-shaped or have any arbitrary form. The slit (S) or notch (N) may terminate in an opening (MO) which may be rectangular in shape, or other than rectangular in shape.

In order to divert the surface currents from the surrounding area of a slit (S) or notch (N) and an opening to an area destined for the implanting of a transponder chip module (TCM) with a module antenna (MA) connected to an RFID chip, a flexible circuit (FC) may be used for inductive coupling and harvesting energy. Such flexible circuit (FC) may have a patch antenna (PA) (aka a sense coil (SeC)) to pick-up the surface currents around the area of the slit (S) or notch (N) and opening, conduct such current flows to a coupling loop structure (CLS) having a frame, circular, spiral or helix shape antenna structure (AS) on the flexible circuit (FC) which collects and distributes current flows and inductively couples with the module antenna (MA) of the transponder chip module (TCM) by means of the patch antenna (PA). The flexible circuit (FC) may be replaced by a rigid circuit (RC). For the purpose of clarity, a transponder chip module (with contact pads) may be replaced or interchanged by an RFID chip module (having no contact pads) for application in high (HF) and ultra-high frequency (UHF) proximity cards and contactless payment cards.

According to the invention, generally, proximity cards or contactless smartcards can be manufactured from folding a metal layer to form a metal card body (MCB) having the dimensions of a standard ID-1 smartcard comprising (i) a slit in the metal layer which extends from a perimeter edge to a shaped opening or window and (ii) folding the metal layer in the middle on one fold line to form a sandwich having a separation gap at the edge of the card body, or folding the metal layer on two fold lines forming wings which are folded back onto the card body with a separation gap between the two wings in the center of the card body, and after folding and pressing the metal layers together forming a proximity card having ID-1 dimensions which is ISO compliant; and (iii) said ID-1 proximity card having an antenna structure (AS) on a flexible or rigid circuit sandwiched powering an RFID chip between the folded metal layer or metal layers to overlap or overlie the slit or slits, opening or openings, and the isolation gap between the folded metal layer on layers forming the metal card body (MCB).

According to the invention, generally, a contactless metal face/metal hybrid smartcard has a booster antenna (BA) arranged on a rear plastic layer laminated to a front metal layer having a slit (S). The booster antenna may have three portions, or components: (i) a perimeter coil (PC) component extending around a peripheral area of the card body, and having one or more turns; (ii) a coupling or coupler coil (CC) component located at the module opening (MO) for coupling with a module antenna (MA) in the transponder chip module (TCM), and having one or more turns; and (iii) a sense coil (SeC) component arranged around the slit (S) in the front metal layer, and may overlap the slit (S), typically in a zigzag fashion or the like. The sense coil may have a loop, spiral or helix shape. The booster antenna may form a closed loop circuit, and may have no free ends. Alternatively, the booster antenna may form an open loop circuit, and may have free ends.

The invention may be applicable to contactless-capable cards such as proximity cards (PC), and smartcards (SC) having metal layers (ML) with slits (S) to function as coupling frames (CF). Some of the descriptions directed to ID-1 size smartcards may be applicable to proximity cards, and vice-versa. The smartcards (SC) may be contactless only, or may be dual interface (DI) having both contactless and contact capability. Contactless capability relies on establishing a radio frequency (RF) connection between the card and an external contactless reader, such as a point-of-sale (POS) terminal. Contact capability is relatively straightforward, involving having contact pads (CP) on an exposed face of the transponder chip module (TCM), for interfacing with an external contact type reader, such as an automatic teller machine (ATM).

According to some embodiments (examples) of the invention, a method of making a card body (CB) for an RFID device of a given size may comprise: providing an oversize metal layer (OML) having a full size middle portion (MP) flanked by two half size side portions (SP) extending from opposite side edges of the middle portion; folding the two side portions, towards each other, over the middle portion so that their outer edges (oe) oppose and nearly touch each other, leaving a slit (S) therebetween. An insulating layer may be provided between the middle portion and the side portions. A full size module opening (fMO) may be provided in the middle portion; and a half size module opening (hMO) may be provided in each of the side portions. The side portions may be folded over the middle portion so that the half size module openings oppose each other, and together form a full size module opening. A slit (S) may be provided in the middle portion. After folding, one (or both) of the outer edges may be trimmed. An antenna structure may be provided which is adjacent to or overlaps the slit. The RFID device may be a smartcard (SC) or a proximity card (PC).

The middle portion may represent a first metal layer (ML-1); the folded over side portions may represent a second metal layer (ML-2). An RFID chip module may be provided between the two metal layers. Both metal layers may be provided with a slot to accept a lanyard.

According to some embodiments (examples) of the invention, a smartcard may comprise: a coupling frame (CF) comprising a metal layer (ML) with a slit (S); and a booster antenna (BA). The booster antenna may comprise a sense coil (SeC) disposed in, or across, or overlapping the slit, including an area adjacent to the slit. Ferrite may be disposed between the booster antenna and the coupling frame. The smartcard may be a contactless smartcard, or a dual interface (contactless and contact) smartcard.

The booster antenna may comprise: a perimeter coil (PC) component extending around a peripheral area of the card body, and having one or more turns; a coupling or coupler coil (CC) component located at the module opening for coupling with an antenna (MA) in the transponder chip module, and having one or more turns; and a sense coil (SeC) component located at an area of the slit. The sense coil may have a zigzag, loop, helical or spiral shape. The sense coil may cross over the slit several times, perpendicular to and overlapping the slit. The sense coil may traverse back and forth (meander) in the slit, parallel to the slit. The sense coil may act like a pickup coil) interacting/coupling with the coupling frame, at the location of the slit, and may comprise one or more of the following:
the sense coil comprises embedded wire, and traverses the slit a number of times, generally perpendicular to the slit, including an area outside of the slit;
the sense coil comprises embedded wire, and zigzags, extending generally parallel to the slit, including an area outside of the slit;
the sense coil comprises embedded wire in the form of a spiral, or the like, overlapping the slit; and
the sense coil comprises a conductive track, or “ribbon”, such as in US 2018/0341847, and extends parallel inward, cross the slit, and extend parallel outward, including overlapping an area outside of the slit.

The booster antenna may comprise wire embedded in a plastic layer (PL). Ferrite may be disposed between the plastic layer and the coupling frame. The ferrite may be disposed only on an area on the plastic layer which is within (interior) to the booster antenna and which is not occupied by the booster antenna.

The booster antenna may form a closed loop, with no free ends. The booster antenna may form an open loop circuit, with free ends

The smartcard may further comprise a transponder chip module (TCM) capable of functioning in at least a contactless mode. The transponder chip module may have contact pads for functioning in a contact mode.

In an embodiment of the invention, the flexible circuit (FC) with a patch antenna (PA) or sense coil (SeC) to pick-up the surface currents around the area of a slit (S) or notch(es) (N) and an opening may be connected directly to the RFID chip without the need for a module antenna. In other words, the connection pads or terminal ends on the RFID chip are physically connected to the coupling loop structure (CLS) with an antenna structure (AS).

A Coil on Chip (CoC) device may also find application in HF and UHF proximity cards.

In an embodiment of the invention, a contactless metal clamshell card, metal layered card or solid metal card adhering to the physical dimensions of ISO/IEC 7810 ID-1 format to serve as a proximity card (or “prox” card) in the application of identification, access control or payment may be prepared with a slot or aperture punched or laser-cut through the metal layer or layers. The slot through the metal layer(s) of the ISO card body format may have the dual purpose of allowing for electromagnetic reception and transmission to and from an embedded RFID chip module (without contact pads) or Coil on Chip (CoC) device interfacing with a coupling loop structure (CLS) sandwiched between the metal layers, and for attachment to a lanyard. The metal layers may have a slit which starts at a perimeter edge of the metal card body and terminates in the lanyard slot.

The lanyard slot or opening in the metal layer or layers may be prepared with an insulating insert or snap mechanism made of plastic, glass or wood to allow for an enlargement of the opening in the metal layer or layers, and or to protect any circuitry exposed in the opening area.

An RFID chip module with a module antenna (MA), a flexible circuit (FC) with patch antenna (PA) and a coupling structure (CLS) with an antenna structure (AS), or a flexible circuit (FC) with an antenna structure (AS) connected to an RFID chip may reside under said insulating medium and simultaneously be adjacent, overlapping or overlying the metal layer or layers, slit and opening.

A slit (S) passing entirely through a metal layer or layers may extend from a perimeter edge of the metal card body (MCB) to a distance close to the lanyard slot or terminate in the lanyard slot.

A single metal layer may be folded on itself to form the metal card body (MCB) in ID-1 format. The metal layer or layers (ML) may be stamped and prepared with perforations for bending at one edge or two edges to form the metal card body (MCB). The metal layer or layers (ML) may have indents or pouches to accept an electronic component such as an RFID chip module. In addition, the metal layer or layers (ML) may have a slit (S) and when folded, the slit follows the direction of the fold at the edge of the metal card body. Ferrite may be used for shielding or for forming an inductive barrier between metal layers having current flows of opposite direction. The slit (s) along the edge of a metal card body (MCB) may terminate in an opening or window which may have a particular form and shape.

The metal layers of the card body may be hermetically sealed using an adhesive or the metal layers may be riveted together. The metal layers may be joined together using a ratchet mechanism or the metal layers may be welded together. In particular the metal layers may be joined together at one edge of the metal card body to avoid folding of a single metal layer.

The metal layers may be a combination of different metals such as titanium, stainless steel or an alloy, layered together, to regulate the weight of the proximity card. The metal layers of different material may be fused together to produce a composite structure.

The metal layers may be separated and fused together by a non-conducting oxide layer, a ceramic layer or a dielectric layer.

In another embodiment of the current invention, the joining and the electrical connection of the metal layers by means of spot welding or riveting may be used to direct the surface currents along the perimeter edges and within the metal card body (MCB). Such electrical connection points between metal layers to divert the surface currents to concentrate around an RFID chip module may be achieved with one or multiple connection points.

In an embodiment of the invention, a slit in a metal layer or layers is replaced by the separation distance or gap between the metal layers. An RFID chip module may be embedded between said metal layers with the concentration density of current being manipulated by the electrical connection point(s) between the metal layers.

In an embodiment of the invention, an RFID chip module or a flexible circuit with an antenna structure (AS) connected to an RFID chip is assembled between the metal layers adjacent, overlapping, overlying or surrounding the aforementioned electrical connection point(s). The RFID chip module (CM) or flexible circuit (FC) with an antenna structure (AS) connected to an RFID chip (IC) may further be disposed in an opening or window. The antenna structure on the flexible circuit (FC) may have a frame, circular, spiral or helix shape antenna formed around said opening or window to pick-up surface currents at or around the electrical connection point(s) between the metal layers. The physical joining of the metal layers to create an electrical connection point between the metal layers may be performed by means of laser welding, riveting or soldering. A recess or pouch in a metal layer or in both metal layers may be formed to house the RFID chip module or flexible circuit. The metal card body may be disposed with a slot to accept a lanyard while at the same time the aperture in the metal card body enhances the RF performance of the RFID chip module assembled adjacent or overlapping or overlying said slot or aperture. The slot or aperture passing through the entirety of the metal card body may be further disposed with a slit extending inward to an area around the electrical connection point(s). The RFID chip module (CM) disposed with a module antenna (MA) having a spiral, circular, frame or helix shape antenna may be assembled to be adjacent or overlapping or overlying the inward extending slit and/or slot. A variation in the construction of the proximity card or contactless smartcard may support a slit extending from a perimeter edge on each metal layer to the lanyard slot to further enhance RF performance.

In an embodiment of the invention, the slit may have a typographic form such as the contour of a signature. The sides of the proximity card may have indents or notches for handling.

In an embodiment of the invention, proximity cards or contactless smartcards may comprise a metal layer initially having approximately twice the dimensional size of a standard ID-1 smartcard having a slit in the middle of the oversized metal layer which extends from a perimeter edge to a shaped opening or window in the metal. By folding the metal layer lengthwise on two fold lines which are separated by a distance equal to the width of a single ID-1 card, the folded metal wings, for example with a dimensional width of half an ID-1 card, can be bent and pressed inwards to form a proximity card having ID-1 dimensions which is ISO compliant. After folding the metal wings inwards, the card body is planar with a nominal thickness of 0.76 mm Each folded metal wing can be straight or have a defined shape, and the dimensions of each wing can be the same or different, but when the wings are folded inwards and pressed flat they precisely meet, for example in the center, leaving just an isolation gap between the folded wings.

Folding the oversized metal layer on two fold lines is exemplary of the disclosure, and a proximity card in ID-1 format could equally be formed from an oversized metal layer based on one fold line. The folded wings are separated by an isolation gap in the middle of the card body, but equally the isolation gap could be at the edge of the card body, if one fold had been chosen. An adhesive layer may be applied to the card construction to fix the folded metal wings in place.

The ID-1 proximity card may further comprise of an antenna structure (AS) on a flexible or rigid substrate (circuit) assembled between the folded metal wings around the area of the lower and upper openings with slit. In other words, the flexible or rigid substrate with an antenna structure (AS) is sandwiched between the folded metal wings separated by a small gap, and the substrate is mounted around the area of openings and or slits. The antenna structure (AS) or tracks may be routed on both sides of the flexible or rigid circuit (double sided antenna structure) with its end portions connected directly to an RFID chip or via inductive coupling to an RFID chip module having a module antenna.

Other electrical components/elements such as a sensor or light may be integrated into the antenna structure (AS), and the antenna structure (AS) may be protected by a transparent, translucent or opaque material assembled around the area of the openings.

The geometry of the antenna structure (AS) may resemble a flat helix antenna design. The metal layers may be electrically connected to the doubled sided antenna structure. For the purpose of clarity, the folding of the oversized metal layer may be at any of the four sides which form the metal card body (MCB), the slit or slits may commence at any perimeter edge of the four sides, and the opening or openings in the metal layer (ML) to which the slit or slits transcend may commence at a card body edge and extend to a front face or an rear face of the metal card body (MCB). In the teachings set out above and below, the folded oversized metal layer to form two metal layers to capture surface currents is exemplary and not limited to the scope of the invention. Further, the helix antenna module is also exemplary of an antenna structure to pick-up surface currents.

According to an embodiment of the invention, contactless cards operating in contactless mode including dual interface (contact and contactless) smartcards may have a coupling frame (CF) and a booster antenna (BA) arranged in a metal card body (MCB) to inductively interact in an electromagnetic field, allowing for enhanced radio frequency performance. The metal card body may have a front face metal layer (ML) and a rear plastic layer (PL) with contactless communication possible from both sides of the card body. The booster antenna (BA) may comprise of a coupler coil (CC), perimeter coil (PC) (aka card antenna (CA)), a sense coil (SeC) and in some circumstances an extension antenna (EA) which collectively harvest and distribute energy with the front face metal layer (ML) having at least one slit (S) to act as a coupling frame (CF). The slit (S) may be a narrow gap or notch in the metal layer (ML) or the slit (S) may be an enlarged gap in the form of an opening in the metal layer (ML) or the slit (S) may be a narrow gap accompanied by an opening in the metal layer (ML). The sense coil (SeC) forming part of the perimeter coil (PC) of the booster antenna (BA) may have a single turn or multiple turns in the shape of a loop, spiral or zigzag antenna which overlaps or overlies a slit and or opening in the metal layer (ML). The perimeter coil (PC) may have a single turn or multiple turns (windings) running along the outer edges of the card body and the coupler coil (CC) may have a single turn or multiple turns to inductively couple with the module antenna (MA) of the transponder chip module (TCM). For optimum pick-up and distribution of surface currents, opposing slits and or openings may be formed in the metal card body (MCB).

In their various embodiments, the invention(s) described herein may relate to industrial and commercial industries, such RFID applications, proximity cards, contactless payment smartcards (metal, plastic or a combination thereof), electronic credentials, identity cards, loyalty cards, access control cards, wearable devices, and the like.

Other objects, features and advantages of the invention(s) disclosed herein may become apparent in light of the following illustrations and descriptions thereof.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be stylized, simplified or exaggerated, others may be omitted, for illustrative clarity.

Although the invention is generally described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

Some elements may be referred to with letters (“AS”, “CBR”, “CF”, “CLS”, “FC”, “MA”, “MT”, “TCM”, etc.) rather than or in addition to numerals. Some similar (including substantially identical) elements in various embodiments may be similarly numbered, with a given numeral such as “310”, followed by different letters such as “A”, “B”, “C”, etc. (resulting in “310A”, “310B”, “310C”), and may collectively (all of them at once) referred to simply by the numeral (“310”).

FIG. 1 (compare FIG. 1 of 63/040,033) is a diagrammatic view of a conventional proximity access card which may be a clamshell card with a slot for a lanyard, having a printable surface for a logo and photo, according to the prior art.

FIG. 2 (compare FIG. 2 of 63/040,033) is an exploded view of a smartcard (SC) (FIG. 4A of U.S. Pat. No. 9,798,968 with a different orientation) having two coupling frames (CF) in different layers of a card body (CB), according to the prior art.

FIG. 3 (compare FIG. 3 of 63/040,033) is a diagram (plan view, exploded) (FIG. 9 of U.S. Pat. No. 9,697,459 with a different orientation) showing two coupling frames (CF-1, CF-2) each having two ends, and illustrates alternative ways of connecting the ends of one coupling frame to the ends of the other coupling frame, according to the prior art.

FIG. 4A (compare FIG. 4A of 63/040,033) is a diagram (exploded perspective view) of a metal laminated proximity card or smartcard with an aperture or slot in each metal layer of the stack up construction without slit, according to an embodiment of the invention.

FIG. 4B (compare FIG. 4B of 63/040,033) is a diagram (exploded perspective view) of a metal laminated proximity card or smartcard with an aperture or slot and a straight slit in each metal layer of the stack up construction, according to an embodiment of the invention.

FIG. 4C (compare FIG. 4C of 63/040,033) is a diagram (exploded perspective view) of a metal laminated proximity card or smartcard with an aperture or slot and a slit spatially offset in each metal layer of the stack up construction, according to an embodiment of the invention.

FIG. 4D (compare FIG. 4D of 63/040,033) is a diagram (exploded perspective view) of a metal laminated proximity card or smartcard with an aperture or slot and a slit spatially offset in each metal layer of the stack up construction, with the slits having a different orientation to FIG. 4C, according to an embodiment of the invention.

FIG. 5A (compare FIG. 5A of 63/040,033) is a diagram (plan view, exploded) showing two metal layers (ML-1, ML-2) (without a slit) each having an aperture or slot to form a metal card body of a proximity card, and illustrates a one point electrical connection between the metal layers without slit, according to an embodiment of the invention.

FIG. 5B (compare FIG. 5B of 63/040,033) is a diagram (plan view, exploded) showing two metal layers (ML-1, ML-2) with a slit and each having an aperture or slot to form a metal card body of a proximity card, and illustrates a one point electrical connection between the metal layers, according to an embodiment of the invention.

FIG. 5C (compare FIG. 5C of 63/040,033) is a diagram (plan view, exploded) showing two metal layers (ML-1, ML-2) with offset slits of different orientation to FIG. 5B, and each having an aperture or slot to form a metal card body of a proximity card, and illustrates a one point electrical connection between the metal layers, according to an embodiment of the invention.

FIG. 6A (compare FIG. 6A of 63/040,033) is a diagram (plan view, exploded) showing two metal layers (ML-1, ML-2) with a slit extending from an aperture or slot in the metal layers to form a metal card body with an inner slit, and illustrates a one point electrical connection between the metal layers, according to an embodiment of the invention.

FIG. 6B (compare FIG. 6B of 63/040,033) is a diagram (plan view, exploded) showing two metal layers (ML-1, ML-2) with a first slit in each metal layer extending from a perimeter edge to the aperture or slot and a second slit extending from the aperture or slot in the metal layers to form a metal card body, and illustrates a one point electrical connection between the metal layers, according to an embodiment of the invention.

FIG. 6C (compare FIG. 6C of 63/040,033) is a diagram (plan view, exploded) showing two metal layers (ML-1, ML-2) with a slit in the top and bottom metal layer extending from a perimeter edge to the aperture or slot whereby the upper and lower slits are spatially offset to each other, and a second set of slits in the top and bottom metal layers extending from the aperture and slot to form a metal card body, and illustrates a one point electrical connection between the metal layers, according to an embodiment of the invention.

FIG. 7A (compare FIG. 11A of 63/040,033) is a diagrammatic view of a front surface of a metal layer which is double twice the size of an ID-1 card body with two fold lines and a cut-out (half sized opening) located at the top and bottom edge (left hand side) of the metal layer which is later folded on itself along both fold lines to form an ID-1 size card body, according to an embodiment of the invention. FIGS. 7A(1) and 7A(2) show some examples of a card body (CB) having two metal layers (ML-1,ML-2) resulting from folding the oversize metal layer of FIG. 7A.

FIG. 7B (compare FIG. 11B of 63/040,033) shows perspective views of an ID-1 metal card body with two metal edge folds having a cut-out on each fold which meet in the center of the card body to form an opening on the left hand side of the card body and a slit or gap which runs along the perimeter edges and along the center position of the fold, according to an embodiment of the invention. In addition, a detailed view of the slit or gap running along the folded perimeter metal edge of the card body and a detailed view of the slit or gap running along the perimeter edge of the folds with the slit or gap passing through the center of the opening are provided.

FIG. 8A (compare FIG. 13A of 63/040,033) shows diagrammatic views of a front surface of a metal layer double the size of an ID-1 card body with two fold lines, a cut-out (half sized opening) located at the top and bottom edge (left hand side) of the metal layer and a complete opening in the vertical center of the metal layer with a slit which commences at a perimeter edge of the metal layer and enters the opening, according to an embodiment of the invention. The (oversized) metal layer with cut-outs, opening and slit is later folded on itself along both fold lines to form an ID-1 size card body. FIGS. 8A(1) and 8A(2) show some examples of a card body (CB) having two metal layers (ML-1,ML-2) resulting from folding the oversize metal layer.

FIG. 8B (compare FIG. 13B of 63/040,033) shows incremental diagrams illustrating a top view of a metal layer to form a folded ID-1 card body with two folds with each having a cut-out portion of an opening, a full size opening in the unfolded metal layer which later is concentric with the cut-out openings on the two folded wings of the metal layer, according to an embodiment of the invention. A slit commences at the perimeter edge of the unfolded section of the metal layer and enters the opening in said unfolded section. In addition, a top view of a folded ID-1 metal card body is provided showing an opening on the left hand side through the card body and a slit or gap which runs along the perimeter edges and along the center position of the fold. FIGS. 8B(1), 8B(2) and 8B(3) show some examples of a card body (CB) having two metal layers (ML-1,ML-2) resulting from folding the oversize metal layer.

FIG. 9A (compare FIG. 1A of 63/034,965) (compare FIG. 4A of U.S. Pat. No. 9,033,250) is a diagram (plan view) illustrating an embodiment of a booster antenna (BA) with card antenna CA, a coupler antenna (CC) and an extension antenna (EA), according to the prior art.

FIG. 9B (compare FIG. 1B of 63/034,965) (compare FIG. 4B of U.S. Pat. No. 9,033,250) is a diagram (plan view) illustrating an embodiment of a booster antenna (BA) with card antenna CA, a coupler antenna (CC) and an extension antenna (EA), according to the prior art.

FIG. 10 (compare FIG. 2 of 63/034,965) (compare FIG. 2 of US 2018/0341847) is a diagram (plan view) of an exemplary coupling frame antenna with a track width of 3 mm), according to the prior art.

FIG. 11A (compare FIG. 3A of 63/034,965) is a diagram (plan view) showing a metal card body (MCB) and a booster antenna (BA) in a smartcard (SC), with a sense coil (SeC) having an interdigitated or zigzag form with multiple turns and overlapping a slit (S), according to an embodiment of the invention.

FIG. 11B (compare FIG. 3B of 63/034,965) is a diagram (plan view) showing a modification of FIG. 3A in which the slit (S) does not extend to the module opening (MO).

FIG. 11C (compare FIG. 3C of 63/034,965) is a diagram (plan view) showing a metal card body (MCB) and a booster antenna (BA) in a smartcard (SC), with a sense coil (SeC) having a loop or spiral form with multiple turns and overlapping a slit (S), according to an embodiment of the invention.

FIG. 11D (compare FIG. 3D of 63/034,965) is a diagram (plan view) showing a modification of FIG. 3C in which the slit (S) does not extend to the module opening (MO), according to an embodiment of the invention.

FIG. 11E (compare FIG. 3E of 63/034,965) is a diagram (plan view) showing a metal card body (MCB) and a booster antenna (BA) in a smartcard (SC) with a sense coil (SeC) having an interdigitated or zigzag form with multiple turns and overlapping a slit (S) and connected to a multiple loop coupler coil (CC), according to an embodiment of the invention.

FIG. 11F (compare FIG. 3F of 63/034,965) is a diagram (plan view) showing a modification of FIG. 3E in which the slit (S) does not extend to the module opening (MO), according to an embodiment of the invention.

FIG. 11G (compare FIG. 3G of 63/034,965) is a diagram (plan view) showing a metal card body (MCB) and a booster antenna (BA) in a smartcard (SC), with a sense coil (SeC) having a loop or spiral form with multiple turns and overlapping a slit (S) and connected to a multiple loop coupler coil (CC), according to an embodiment of the invention.

FIG. 11H (compare FIG. 3H of 63/034,965) is a diagram (plan view) showing a modification of FIG. 3G in which the slit (S) does not extend to the module opening (MO), according to an embodiment of the invention.

FIG. 12A (compare FIG. 4A of 63/034,965) is a diagram (plan view) showing a metal card body (MCB) and a booster antenna (BA) in a smartcard (SC), with a sense coil (SeC) crossing over a slit (S) several times, perpendicular to and overlapping the slit, according to an embodiment of the invention.

FIG. 12B (compare FIG. 4B of 63/034,965) is a diagram (plan view) showing a metal card body (MCB) and a booster antenna (BA) in a smartcard (SC), with a sense coil (SeC) traversing back and forth (meanders) in a slit, parallel to the slit, and may overlap the slit, according to an embodiment of the invention.

FIG. 12C (compare FIG. 4C of 63/034,965) is a diagram (plan view) showing a metal card body (MCB) and a booster antenna (BA) in a smartcard (SC), with a sense coil (SeC) as part of a perimeter coil (PC) is like a ribbon, running along the edge of the card body, then traverses the slit (perpendicular thereto), and continuous to run parallel to the edge of the card body, according to an embodiment of the invention.

FIG. 13A (compare FIG. 5A of 63/034,965) is a diagram (plan view) showing a metal card body (MCB) and a booster antenna (BA) in a smartcard (SC), with a sense coil traversing back and forth (meanders) in a first slit (S₁), parallel, and may overlap the slit. A second slit (S₂) is a wide gap and the perimeter coil wraps around the slit (S₂), according to an embodiment of the invention.

FIG. 13B (compare FIG. 5B of 63/034,965) is a diagram (plan view) showing a modification of FIG. 5A in which the perimeter coil (PC) forms a meander around and within the area of the second slit (S₂), according to an embodiment of the invention.

FIG. 13C (compare FIG. 5C of 63/034,965) is a diagram (plan view) showing a metal card body (MCB) and a booster antenna (BA) in a smartcard (SC), with a sense coil traversing back and forth (meanders) in a first slit (S₁), parallel, and may overlap the slit. A second slit (S₂) is a wide gap and the perimeter coil is arranged within the area of the slit (S₂), according to an embodiment of the invention.

FIG. 13D (compare FIG. 5D of 63/034,965) is a diagram (plan view) showing a modification of FIG. 5c in which the perimeter coil (PC) is arranged outside the area of the second slit (S₂), according to an embodiment of the invention.

FIG. 14A (compare FIG. 6A of 63/034,965) is a diagram (plan view) showing a metal card body (MCB) and a booster antenna (BA) in a smartcard (SC), with a sense coil (SeC) having a loop or spiral form with multiple turns and overlaps the slit (S). The wire ends of the perimeter coil (PC) are galvanically connected to the chip module (CM), according to an embodiment of the invention.

FIG. 14B (compare FIG. 6B of 63/034,965) is a diagram (plan view) showing a modification of FIG. 6A in which the slit (S) does not extend to the module opening (MO), and the sense coil (SeC) has an interdigitated or zigzag form instead of a loop form with the wire ends of the perimeter coil (PC) connected directly to the chip module (CM), according to an embodiment of the invention.

FIG. 14C (compare FIG. 6C of 63/034,965) is a diagram (plan view) showing a metal card body (MCB) and a booster antenna (BA) in a smartcard (SC), according to an embodiment of the invention. A sense coil (SeC) has an interdigitated or zigzag form with multiple turns and overlaps the slit (S) which does not extend to the module opening (MO). The sense coil (SeC) and the perimeter coil (PC) connected to a multiple loop coupler coil (CC) pick up current flows around the slit and module opening (MO) and direct them to the chip module (CM). The wire ends of the multiple turn coupler coil which overlaps or is adjacent to the module opening (MO) is galvanically connected to the chip module (CM), according to an embodiment of the invention.

FIG. 15 (compare FIG. 7 of 63/034,965) is a diagram (cross-sectional view) showing a metal card body and a booster antenna in a smartcard, according to an embodiment of the invention.

### DRAWING LEGEND

MCB Metal card body
CF Coupling frame
MO Module opening
S Slit
TCM Transponder chip module
BA Booster antenna
PC Perimeter coil
SeC Sense coil
CC Coupling coil
EA Extension antenna
PL Plastic layer

### DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein.

Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

Reference may be made to disclosures of prior patents, publications and applications. Some text and drawings from those sources may be presented herein, but may be modified, edited or commented to blend more smoothly with the disclosure of the present application.

In the main hereinafter, RFID cards, proximity cards, contactless cards, dual interface cards, or tags in the form of pure contactless cards, access control cards, electronic identity cards and secure credential cards may be discussed as exemplary of various features and embodiments of the invention(s) disclosed herein. As will be evident, many features and embodiments may be applicable to (readily incorporated in) other forms of smartcards, such as dual interface cards, EMV payment cards, solid metal cards, metal veneer cards, metal hybrid cards and metal foil cards. As used herein, any one of the terms “transponder”, “tag”, “smartcard”, “data carrier” and the like, may be interpreted to refer to any other of the devices similar thereto which operate under ISO 14443 or similar RFID standard. The following standards are incorporated in their entirety by reference herein:
ISO/IEC 14443 (Identification cards-Contactless integrated circuit cards-Proximity cards) is an international standard that defines proximity cards used for identification and the transmission protocols for communicating with them.
ISO/IEC 15693 is an ISO standard for vicinity cards, i.e. cards which can be read from a greater distance as compared to proximity cards.
ISO/IEC 7816 is an international standard related to electronic identification cards with contacts, especially smartcards.
EMV standards define the interaction at the physical, electrical, data and application levels between IC cards and IC card processing devices for financial transactions. There are standards based on ISO/IEC 7816 for contact cards, and standards based on ISO/IEC 14443 for contactless cards.

A typical RFID chip module (CM) (without contact pads) described herein may comprise:
(i) a flexible circuit (FC) or flexible substrate (FS) which may be referred to as a chip carrier tape (CCT);
(ii) a planar antenna (PA) structure, or simply antenna structure (AS) or module antenna (MA), which may be a laser-etched antenna structure (LES) or a chemically-etched antenna structure (CES), disposed on the flexible circuit (FC) and connected with an RFID chip disposed on the flexible circuit (FC); and
(iii) a coupling loop structure (CLS) having a spiral, circular, frame or helix shape connected directly (via conductive tracks) or inductively coupled to the module antenna (MA).

Generally, any dimensions set forth herein are approximate, and materials set forth herein are intended to be exemplary. Conventional abbreviations such as “cm” for centimeter”, “mm” for millimeter, “μm” for micron, and “nm” for nanometer may be used.

### The Use of a Slit in a Coupling Frame

According to the Prior Art, a coupling frame (CF) may generally comprise a conductive, planar surface or element (such as a conductive layer, or a conductive foil) having an outer edge, and discontinuity such as a slit (S) or a non-conductive stripe (NCS) extending from the outer edge of the conductive surface to an interior position thereof. The coupling frame may be a curved surface, rather than being planar.

Most of the coupling frames may have a “continuous” surface, and may comprise a foil or sheet or layer of metal having a slit (an electrical discontinuity) for overlapping a module antenna and, in some cases having an appropriate opening (MO) for accommodating the mounting of a transponder chip module (TCM).

In use, a coupling frame may be disposed closely adjacent to (in close proximity, or juxtaposed with) a transponder chip module (TCM) having a module antenna (MA) so that the slit (S) overlaps (traverses, over or under) at least a portion of the module antenna. For example, the slit (S) may extend from a position external to the module antenna (MA), crossing over (or overlapping) at least some of the traces of the module antenna, such as extending over all of the traces on one side of the module antenna and may further extend into the interior area (no-man's land) of the module antenna.

In dual interface metal cards according to the prior art, a stack of metal layers each with a slit at different orientations is laminated together to form a metal card body, acting as a coupling frame.

In the current invention, a slit on the same plane as the metal layer may not be a requirement.

But rather the slit is replaced by a gap between the metal layers with an electrical interconnection being provided between said metal layers at a point or position close to the perimeter edge of the metal card body formed by the metal layer sandwich. The gap may be created by a dielectric medium such as an adhesive layer or insulating layer such as a ceramic layer or by means of a non-conductive oxide. The RFID chip module (with module antenna connected to an RFID chip, a coupling loop structure (CLS) with an antenna structure (AS) and in some instances a capacitor, all mounted on the flexible substrate or circuit resides between the metal layers. The coupling loop structure (CLS) may be on a regular dielectric (e.g. polyimide film, PET, PEN, etc.) or on an electromagnetic shielding material for high frequency or ultra-high frequency RFID systems.

The electrical connection point concentrates the surface currents. The component elements of the flexible substrate or circuit are arranged in such a manner to tap into the surface currents to drive the RFID chip. In addition, a slit may be provided in the metal card body to facilitate electromagnetic reception and transmission.

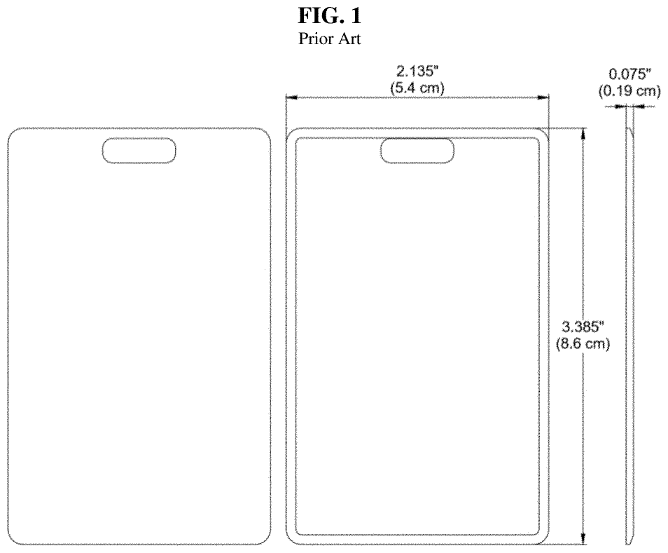

FIG. 1 shows a conventional proximity access card (PC) which may be a clamshell card with a slot for a lanyard, having a printable surface for a logo and photo. The front and side views provide dimensional details of the card which is non ISO compliant. The thickness of the plastic card enclosure gives the card its robustness. The prox card can be used with a strap and clip as a photo ID badge. The artwork can be applied via a photo pouch overlay or by a PVC direct print overlay. To be ISO compliant, the “prox card” may have the dimensions of 85.60 mm (3.370 inches) wide by 53.98 mm (2.125 inches) in height by 0.76 mm (0.030 inches) in thickness.

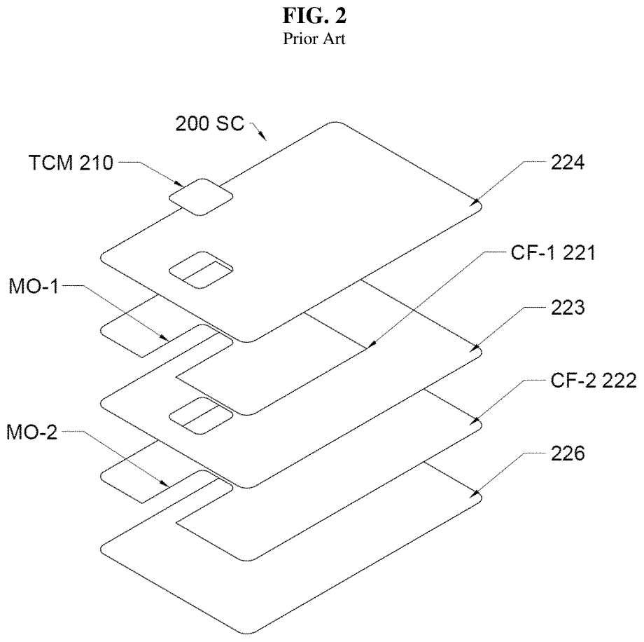

FIG. 2 shows a smartcard 200A having a multiple coupling frame stack-up. Here, there are two coupling frames (CF-1, CF-2) 221, 222 in different layers of the card body (CB), separated by a layer 223 of non-conductive material (such as PVC). The stack-up comprises a front face card layer 224, a first coupling frame (CF-1) 221, an internal card dielectric layer 223, a second coupling frame (CF-2) 222 and a rear face card layer 226.

The first coupling frame (CF-1) surrounds the top, left and bottom edges of the transponder chip module (TCM) 210, and extends to the top, left and bottom edges of the card body (CB), and has a module opening (MO-1). The second coupling frame (CF-2) surrounds the top, right and bottom edges of the transponder chip module (TCM), and extends to the top, right and bottom edges of the card, and has a module opening (MO-2). In aggregate, the first and second coupling frames (which may be referred to as “220”) cover nearly the entire surface of the card body 202 (less the area of the transponder chip module TCM). An activation distance of 40 mm was achieved.

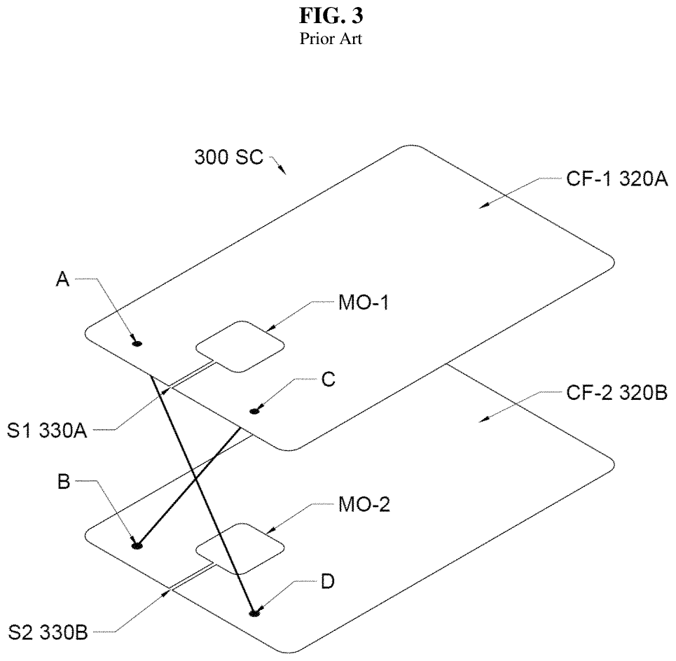

FIG. 3 shows a first coupling frame (CF-1) 320A having two opposing end portions A & C separated by a slit (S1) 930A and a second coupling frame (CF-2) 320B having two opposing end portions B & D separated by a slit (S2) 330B. The slits S1 and S2 may be aligned with one another. Alternatively, the slits S1 and S2 may not be aligned with one another. The end portions A and B may be aligned with one another. The end portions C and D may be aligned with one another.

The end portions of one coupling frame may be connected with the end portions of another coupling frame, in various combinations. For example, in the case of two connected coupling frames the connection may be represented as shown in FIG. 3. The metal region to each side of the slit on two co-planar or overlapping coupling frames may be denoted by the letters A, B, C and D. Various connection options may be:
A connected with D, and B connected with C (as illustrated);
A connected with D, B and D not connected;
B connected with C, A and D not connected;
A connected with B, and C connected with D;
A connected with B, C and D not connected;
C connected with D, A and B not connected.

The connection may be any form of electrical connection including soldered wire, plated through hole, wire bond, conductive adhesive, crimp, ribbon wire, etc. The use of different connection configurations may yield different resonant frequency values when the “composite” coupling frame (2 or more connected coupling frames) is paired with a suitable TCM. The use of multiple coupling frames can be used to increase communication performance of the device by tuning and/or by increasing the effective size of the coupling frame by electrically linking individual coupling frames that are spatially separated. This may be particularly relevant in the case of payment objects such as payment bracelets.

In FIG. 3, module openings MO-1 and MO-2 are shown at the ends of the slits S-1 and S-2 in the two coupling frames CF-1, CF-2, respectively, for receiving a transponder chip module (not shown). It should be understood that the slits S-1 and S-2 need not terminate in module openings, in many of the embodiments disclosed herein, an opening for the module is not required. The important thing is that the slit(s) are positioned to overlap the module antenna of the transponder chip module.

The techniques disclosed herein may be applicable to coupling frames having slits, without module openings, and disposed so that the slit of a coupling frame overlaps at least a portion (such as one side of) a module antenna (such as a rectangular spiral planar etched antenna structure).

Proximity Card or Contactless Smartcard with Integrated Coupling Frame

Proximity cards, contactless smartcards or dual interface smartcards having (i) two metal layers (without a slit extending to a perimeter edge) forming an ISO compliant metal card body, separated by an isolation gap or a dielectric and electrically connected at one or multiple positions/points close to the perimeter edge of the metal card body to act as a coupling frame; (ii) an RFID chip module with a module antenna or a flexible circuit with an antenna structure (AS) connected to an RFID chip is assembled between the metal layers adjacent, overlapping, overlying or surrounding the electrical connection point(s); (iii) the RFID chip module or flexible circuit with an antenna structure (AS) connected to an RFID chip may further be disposed in an opening or window. The antenna structure (AS) may have a frame, circular, spiral or helix shape formed around said opening or window to pick-up surface currents at or around the electrical connection point(s) between the metal layers: (iv) the physical joining of the metal layers to create an electrical connection point between the metal layers may be performed by means of laser welding, riveting or soldering; (v) a recess or pouch in a metal layer or in both metal layers may be formed to house the RFID chip module or flexible circuit; (vi) the metal card body may be disposed with a slot to accept a lanyard while at the same time the aperture in the metal card body enhances the RF performance of the RFID chip module; and (vii) the slot or aperture passing through the entirety of the metal card body may be further disposed with a slit extending inward to an area around the electrical connection point(s). A variation in the construction of the proximity card, contactless smartcard or dual interface smartcard may support a slit extending from a perimeter edge on each metal layer to the lanyard slot to further enhance RF performance.

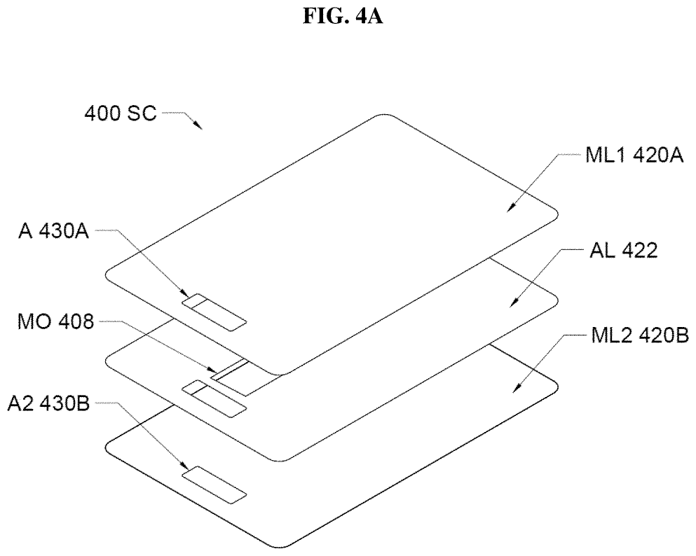

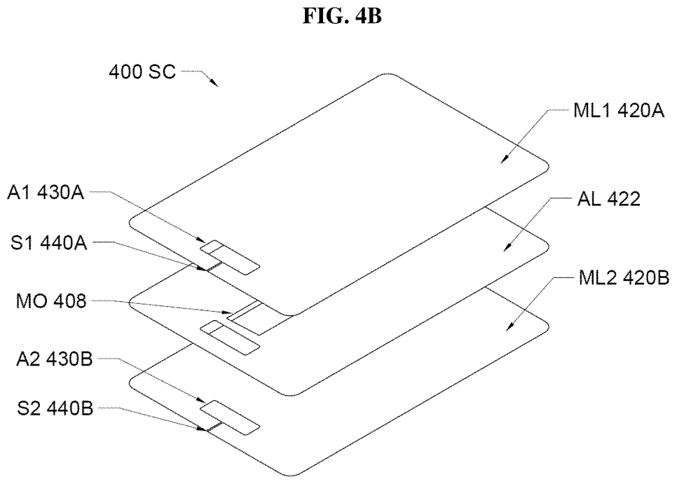

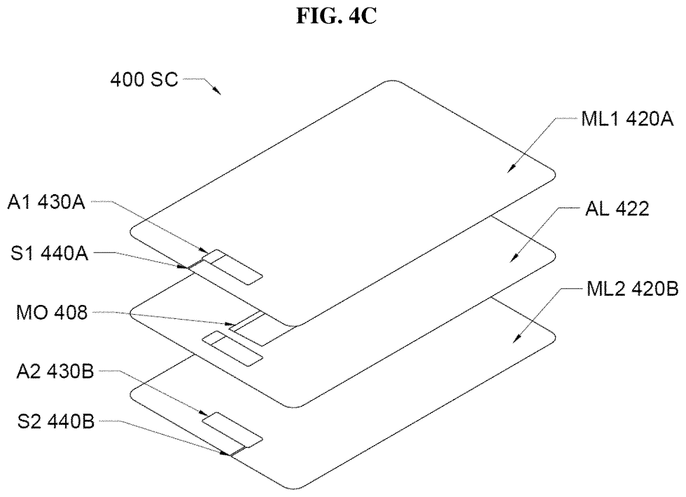

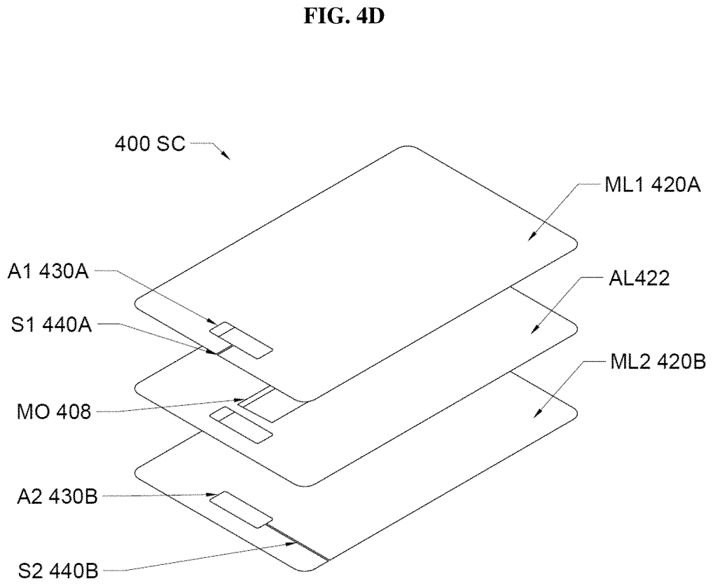

FIG. 4A shows a metal laminated proximity card or contactless smartcard (RFID device) 400, generally comprising (from top-to-bottom, as viewed): a first, top (front) metal layer (ML1) 420A which may have a thickness of approximately 350 μm. The front layer may comprise stainless steel, titanium, aluminum or any non-magnetic metal foil or sheet material. The metal layer may be coated with a lacquer, DLC or a ceramic finish. The metal layer may have a recess or a pouch to accept an RFID chip module (not shown). An aperture or slot (A1) 430A in the first metal layer 420A is shown in the middle of the card body at the left perimeter edge. A layer of non-conductive adhesive 422 may have a thickness of approximately 60 μm (if the front and rear metal layer is 350 μm), to achieve an overall thickness of 760 μm, after lamination. A thicker layer or two thinner layers of adhesive (which may include a dielectric of PET or PEN layer) may be used if the front and rear metal layers are below 350 μm). A second metal layer (ML2) 420B may have a thickness of approximately 350 μm for uniformity. The bottom layer may comprise titanium or any other metal foil material as mentioned above. An aperture or slot (A2) 430B in the rear metal layer is shown. An opening (MO) in the adhesive layer or dielectric layer 408 is prepared to accept an RFID chip module (not shown).

The gap created between the sandwich of two metal layers 420A and 420B represents the RFID slit technology, a replacement for a physical slit passing or cutting through the entirety of each metal layer. One further step is required to the card configuration in order for the card to act as a coupling frame.
400 smartcard (SC)
420A metal layer (ML-1) of a card body (CB), or a metal card body (MCB)
430A aperture (A1) in the ML-1
422 adhesive layer for joining the metal layers ML-1 and ML-2
408 module opening (MO) in the adhesive layer 422 for receiving an RFID chip module
(CM) not shown
420B metal layer (ML-2) of a card body (CB), or a metal card body (MCB)
430B aperture (A2) in the ML-2

FIG. 4B shows a metal laminated proximity card or smartcard with an aperture or slot and a straight slit in each metal layer of the stack up construction (slit 1: 440 A in metal layer ML1 420A and slit 2: 440B in metal layer 2 ML2 420B). The slit (440A and 440B) in each metal layer commences at a perimeter edge on the aperture side of the card body to function as a coupling frame for contactless communication.
400 smartcard (SC)
420A metal layer (ML-1) of a card body (CB), or a metal card body (MCB)
430A aperture (A1) in the ML-1
440A slit 1 in metal layer ML-1
422 adhesive layer for joining the metal layers ML-1 and ML-2
408 module opening (MO) in the adhesive layer 422 for receiving an RFID chip module
(CM) not shown
420B metal layer (ML-2) of a card body (CB), or a metal card body (MCB)
430B aperture (A2) in the ML-2
440B slit 2 in metal layer ML-2

FIG. 4C shows a metal laminated proximity card or smartcard with an aperture or slot and a slit spatially offset in each metal layer of the stack up construction (slit 1: 440 A in metal layer ML1 420A and slit 2: 440B in metal layer 2 ML2 420B). The slit (440A and 440B). The slit (440A and 440B) in each metal layer commences at a perimeter edge on the aperture side of the card body but spaced apart on the long side of the aperture to provide mechanical robustness and to function as a coupling frame for contactless communication.

FIG. 4D shows a metal laminated proximity card or smartcard with an aperture or slot and a slit spatially offset in each metal layer of the stack up construction. The slit (slit 1: 440A and slit 2: 440B) in each metal layer commences at a perimeter edge, one on the long side of the aperture in the middle and the other on the bottom short side of the aperture, with the slits spaced apart to provide mechanical robustness and to function as a coupling frame for contactless communication.

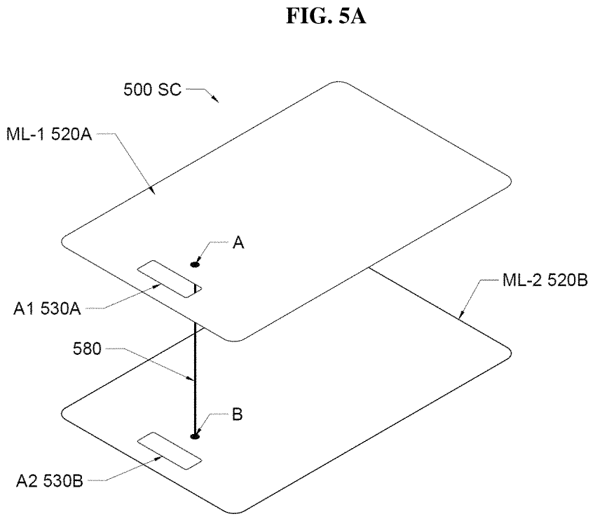

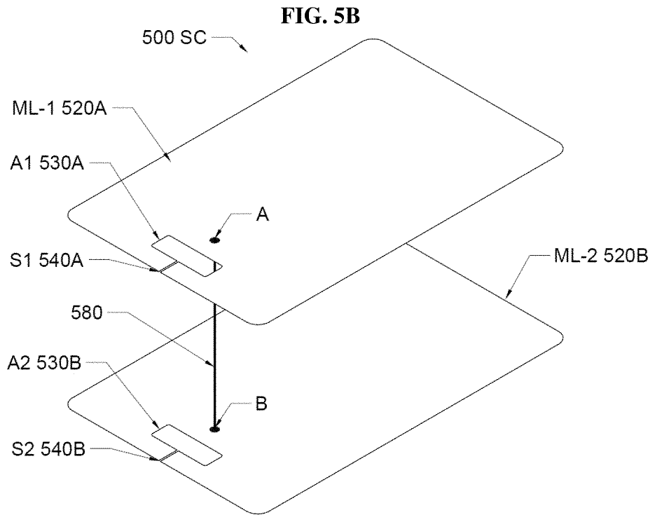

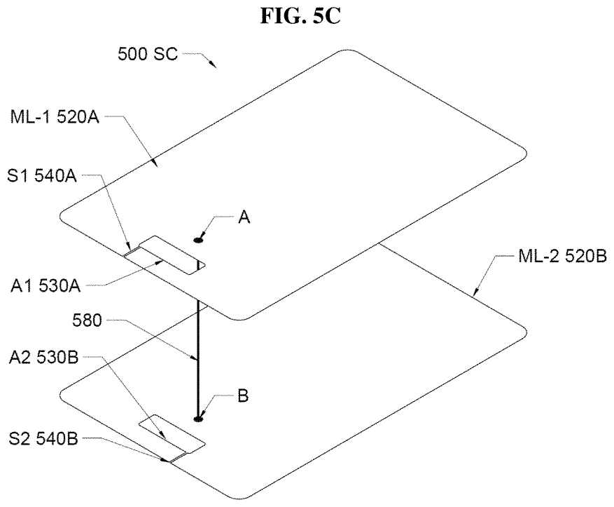

FIG. 5A shows two metal layers (ML-1, ML-2) (without a slit) each having an aperture or slot forming a metal card body, and illustrates the electrical connection (symbolic of the fusing or joining of the overlapping metal layers through welding or riveting) at a point close to the perimeter edge of the metal card body, and the aperture. The RFID chip module assembled between the metal layers is not shown. A variation of the drawing may include a laser cut slit extending from a perimeter edge on each metal layer and terminating in the respective lanyard slot (A1 and A2-530 A and B) as presented in FIGS. 5B and 5C.

The diagram shows a first metal layer (ML-1) 520A having a slot 530A in the metal layer. The second metal layer 520B has an aperture 530B. The connection point or points of one metal layer (ML-1) may be connected with the opposing connection point or points of the other metal layer (ML-2), in various combinations. The metal region or position to each side on two overlapping metal layers may be denoted by the letters A and B. The connection may be any form of electrical connection including soldering, through-hole plating, conductive adhesive, crimping, welding, riveting, etc. The electrical connection renders the metal layers to act as coupling frames. The joining or electrical connection is represented by 580.
500 smartcard (SC)
520A metal layer (ML-1) of a card body (CB), or a metal card body (MCB)
530A aperture (A1) in the ML-1
adhesive layer for joining the metal layers ML-1 and ML-2 (not shown)
580 A and B connection points
520B metal layer (ML-2) of a card body (CB), or a metal card body (MCB)
530B aperture (A2) in the ML-2

FIG. 5B shows two metal layers (ML-1, ML-2) with a slit (slit 1: 540A and slit 2: 540B) and each having an aperture or slot to form a metal card body of a proximity card or contactless smartcard, and illustrates a one point electrical connection between the metal layers. The slit in each metal layer commences at a perimeter edge on the aperture side of the card body and enters the aperture in the middle on the long side, to function as a coupling frame for contactless communication.
500 smartcard (SC)
520A metal layer (ML-1) of a card body (CB), or a metal card body (MCB)
530A aperture (A1) in the ML-1
540A slit 1 in metal layer ML-1
adhesive layer for joining the metal layers ML-1 and ML-2 (not shown)
580 A and B connection points
520B metal layer (ML-2) of a card body (CB), or a metal card body (MCB)
530B aperture (A2) in the ML-2
540B slit 2 in metal layer ML-2

FIG. 5C shows two metal layers (ML-1, ML-2) with offset slits (slit 1: 540A and slit 2: 540B) and each having an aperture or slot to form a metal card body of a proximity card or contactless smartcard, and illustrates a one point electrical connection between the metal layers. The slit in each metal layer commences at a perimeter edge on the aperture side of the card body but spaced apart on the long side of the aperture to provide mechanical robustness and to function as a coupling frame for contactless communication.

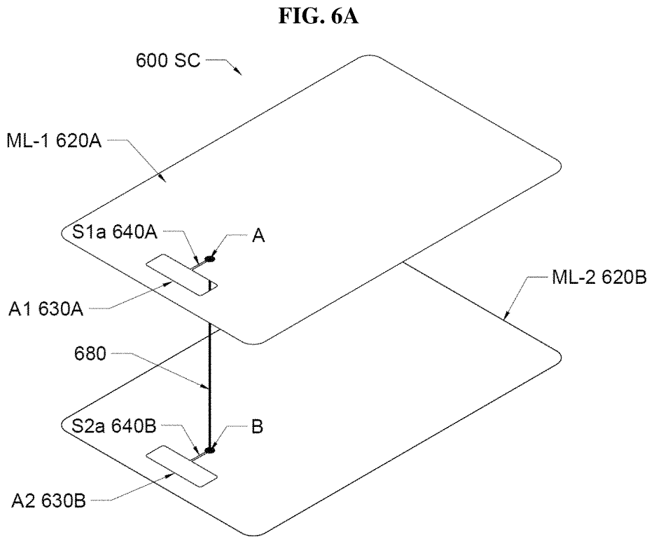

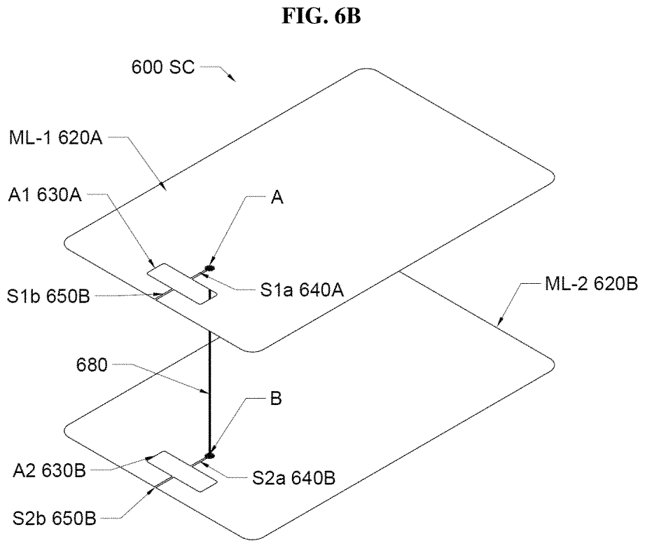

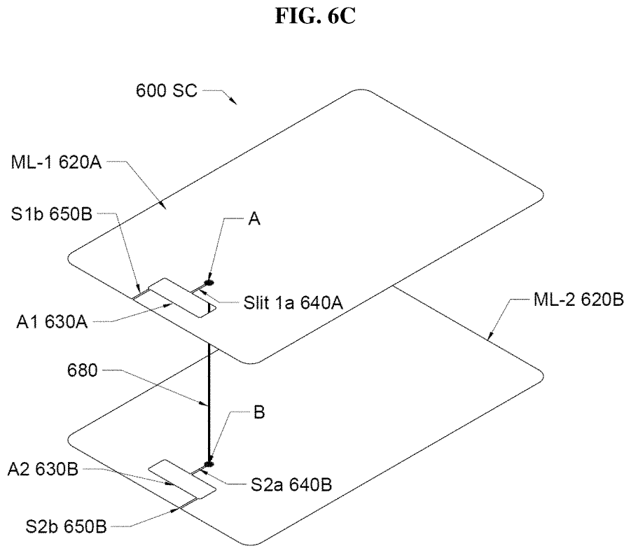

FIG. 6A shows two metal layers (ML-1, ML-2) with a slit (slit 1a: 640A, slit 2a: 640B) in each metal layer, extending into the card body from an aperture or slot (630A, 630B) in the metal layers to form a metal card body, and illustrates a one point electrical connection 680 between the metal layers. The two connection points A and B render the metal layers as coupling frames. The gap between the metal layers represents the slit and the concentration of surface current is at the connection points A and B. By introducing a slit from each aperture (630A, 630B) to the connection point (680), the surface current can be directed to overlap the RFID chip module (not shown). The RFID chip module is disposed with a module antenna connected to an RFID chip and in addition, a coupling loop structure on the same substrate may be used to sense or pick-up the surface current around the connection point and the slits extending from the area of the aperture. A variation of the drawing may include a laser cut slit extending from a perimeter edge on each metal layer and terminating in the respective lanyard aperture (A1 and A2-630 A and B), as is presented in FIGS. 6B and 6C.
600 smartcard (SC)
620A metal layer (ML-1) of a card body (CB), or a metal card body (MCB)
630A aperture (A1) in the ML-1
640A slit 1a in metal layer ML-1
adhesive layer for joining the metal layers ML-1 and ML-2 (not shown)
680 A and B connection points
620B metal layer (ML-2) of a card body (CB), or a metal card body (MCB)
630B aperture (A2) in the ML-2
640B slit 2a in metal layer ML-2

FIG. 6B shows two metal layers (ML-1, ML-2) with a first slit in each metal layer (slit 1b: 650A, slit 2b: 650b) extending from a perimeter edge to the center position on the long side of the aperture, and a second slit extending from the aperture or slot in the metal layers (slit 1a: 640A, slit 2a: 640b) to form a metal card body, and illustrates a one point electrical connection between the metal layers.
600 smartcard (SC)
620A metal layer (ML-1) of a card body (CB), or a metal card body (MCB)
630A aperture (A1) in the ML-1
640A slit 1a in metal layer ML-1
650B slit 1b in metal layer ML-1
adhesive layer for joining the metal layers ML-1 and ML-2 (not shown)
680 A and B connection points
620B metal layer (ML-2) of a card body (CB), or a metal card body (MCB)
630B aperture (A2) in the ML-2
640B slit 2a in metal layer ML-2
650B slit 2b in metal layer ML-2

FIG. 6C shows two metal layers (ML-1, ML-2) with a slit in the top and bottom metal layer (slit 1b: 650A, slit 2b: 650b) extending from a perimeter edge to the aperture whereby the upper and lower slits are spatially offset to each other, and a second set of slits in the top and bottom metal layers (slit 1a: 640A, slit 2a: 640b) extending from the aperture or slot to form a metal card body, and illustrates a one point electrical connection between the metal layers. The slit in each metal layer commences at a perimeter edge on the aperture side of the card body but spaced apart on the long side of the aperture to provide mechanical robustness and to function as a coupling frame for contactless communication.

Folding a Single Metal Layer to Make a Card Body with Two Metal Layers

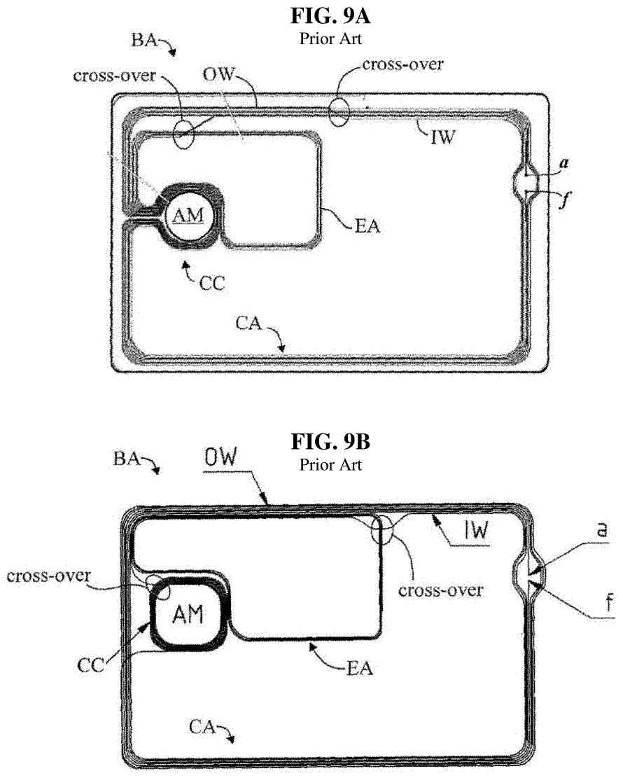

Card bodies with two (or more) metal layers, each having a slit and functioning as a coupling frame are known. See, for example, US 20160110639, which describes stacked and overlapping coupling frames, wherein for example (text abridged): S66
FIG. 6 shows having two coupling frames (CF-1) 620A and (CF-2) 620B disposed such that their slits (S1) 630A and (S2) 630B are oriented in different directions from one another . . . with an insulating layer or film (not shown) disposed therebetween, such as an adhesive. (The insulating layer prevents the slit in a given one of the coupling frames from being shorted out by the other coupling frame.)
FIG. 9A shows a card body construction for a smart card (SC).
The card body construction may be layered, as follows:
a first (top) metal layer, having a thickness of approximately 300 μm, and having an opening for receiving the transponder chip module and a slit 930A extending from the opening to an outer edge of the layer, so that the layer may function as a coupling frame 920A.
a layer of adhesive, having a thickness of approximately 20 μm;
a second (middle) metal layer having a thickness of approximately 100 μm.
a layer of adhesive, having a thickness of approximately 20 μm;
a third (bottom) metal having a thickness of approximately 320 μm.

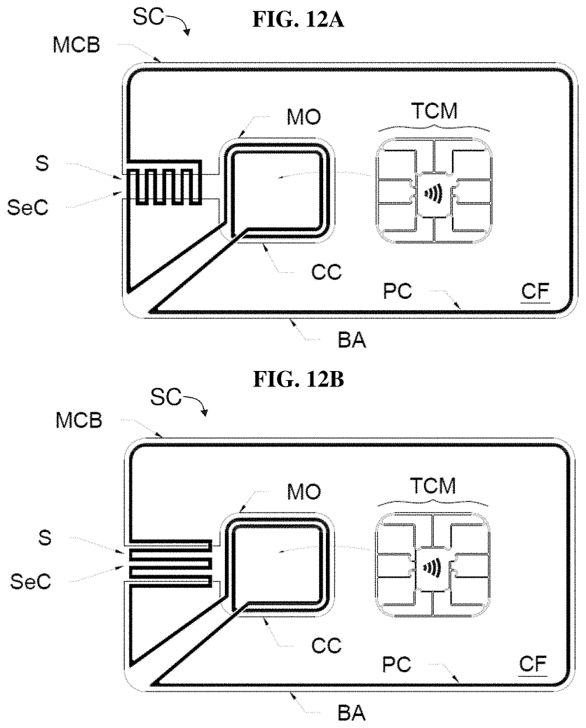

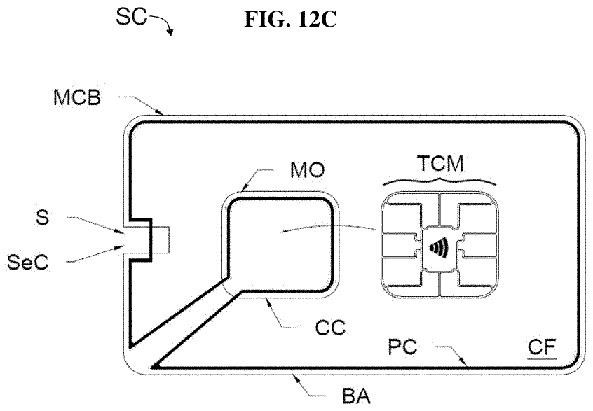

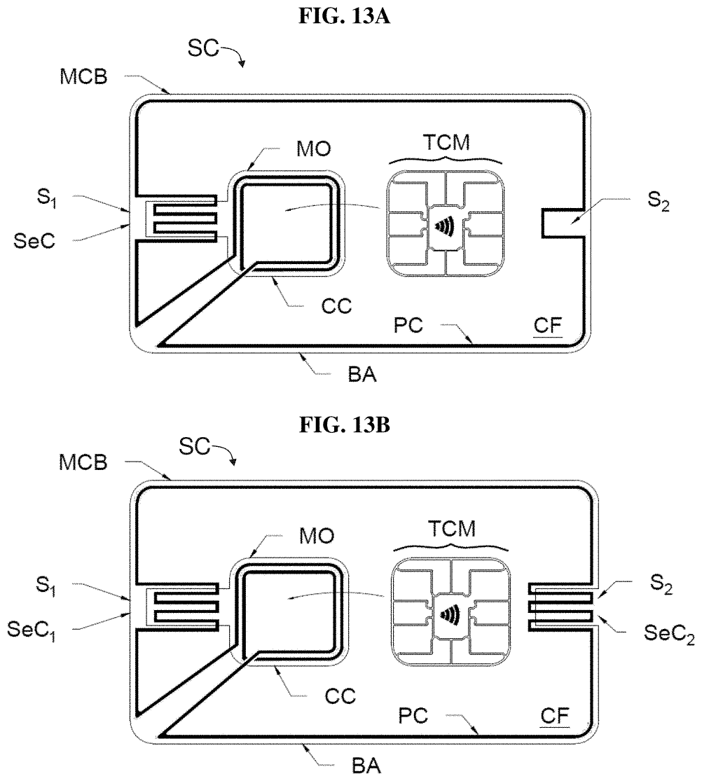

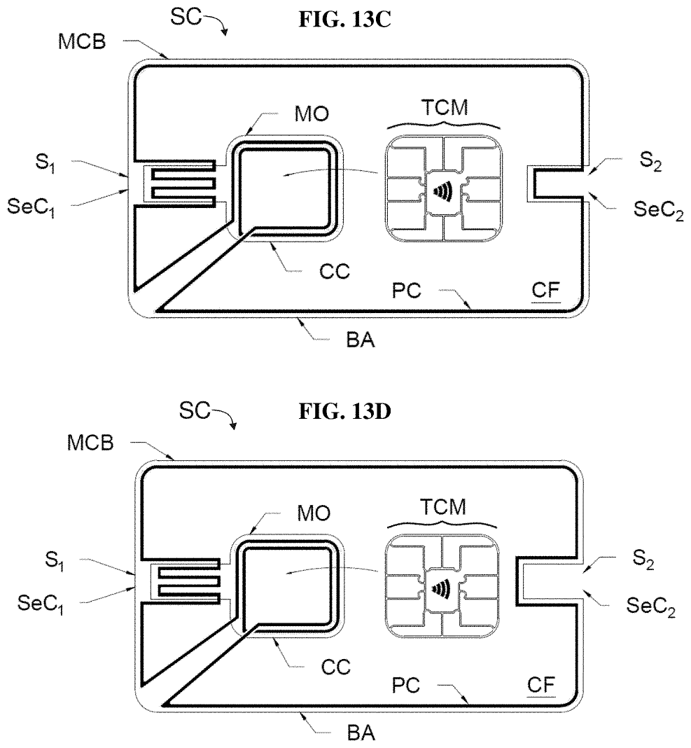

Commonly-owned, copending U.S. Ser. No. 16/991,136 discloses, at FIGS. 12, 13, 14, therein, that a single metal layer may be folded over itself what will become a front layer and rear metal layer, each having a slit (S) and module opening (MO) to act as a coupling frame (CF), and the metal frame (MF) being supported by struts (SRTs) connected to said metal frame (MF) as part of the metal inlay (MI), according to the invention. Foe example:
FIG. 13 (compare FIG. 5 of U.S. 62/979,422) is a front view of a metal inlay (MI) in which the front and rear metal layers, comprising a metal frame (MF) supporting a coupling frame (CF), are folded over on each other at the point (along a line) of perforations (perfs) to create a two-layer metal sandwich, according to the invention.

In the constructions disclosed immediately hereinabove, each metal layer, or each portion of a “double-wide” metal layer may be formed, ab initio, with a slit, so that the resulting metal layer will be able to function as a coupling frame. Most coupling frames will also have module openings, which may also be art of the initial processing of the metal layer, or portion of a double-wide metal layer.

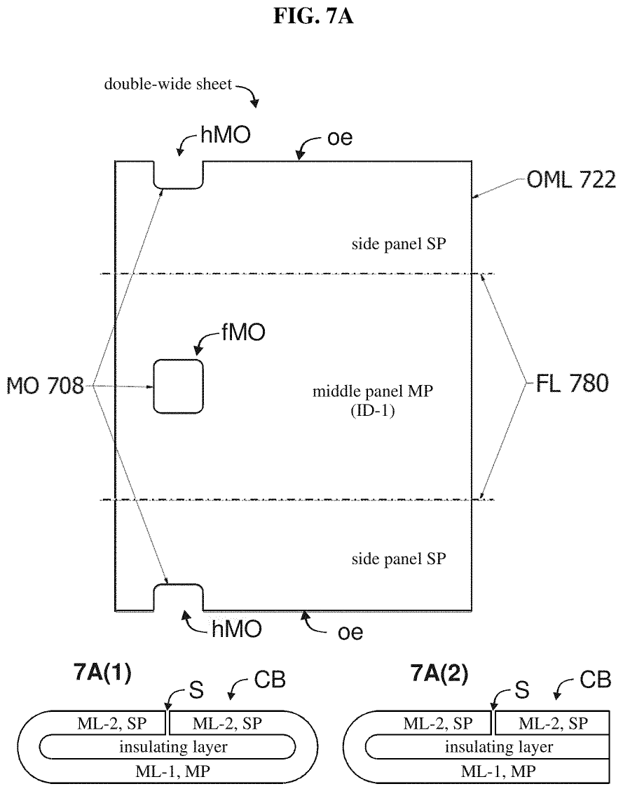

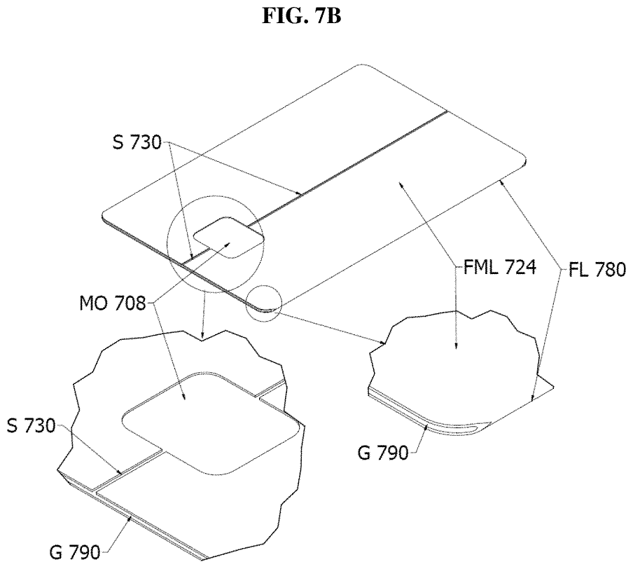

The following FIGS. 7A/B, 8A/B/C) illustrate a method of forming a card body (CB) for an RFID device (such as, but not limited to a smartcard) of a given size (such as, but not limited to ID-1) with two metal layers, each having a module opening and a slit, by:
starting with (providing) a single double-wide (oversize) metal layer (or panel, or sheet) having a full (e.g., ID-1) size middle (or central, or main body) portion or panel (MP) flanked by two half size side (or wing) portions or panels (SP) extending from opposite side edges of the middle portion;
*note that each side portion shares a common inner edge with one of the opposite side edges of the middle portion
forming a full-size module opening (fMO) in the middle portion;
*note that a slit is not required, and may be optional in the middle portion
forming half of a full-size module opening (hMO) in each of the side portions, extending into the side portion from an outer edge (oe) thereof;
*note that slits need not be formed in the side portions
folding the two side portions, towards each other, over the middle portion so that their outer edges (oe) oppose each other, nearly touching one another, leaving a slit (S) therebetween (i.e., between the two outer edges of the two side portions). The two half module openings (hMO) will align with (or oppose) one another (with a slit therebetween) so that together, they form a full module opening

FIGS. 7A(1) and 7A(2) show some examples of a card body (CB) having two metal layers (ML-1,ML-2) resulting from folding the oversize metal layer of FIG. 7A.
FIG. 7A(1) shows that the resulting folded card body (CB) may have two metal layers (ML1, ML2) which are joined or electrically connected with one another on the two outer edges thereof—which would be at the fold lines (or the outer edges of the middle panel). The middle panel (MP) is represented as one metal layer (ML-1). The two folded-over side panels (SP) are represented as the other metal layer (ML-2), which has a slit (S) formed by the adjacent (but not touching) outer edges (oe) of the side portions (SP). An insulating layer, such as adhesive is shown between the two metal layers.
FIG. 7A(2) shows that by trimming one of these edges, such as at the fold line between one of the side panels and the middle panel, the two metal layers may no longer be joined at that edge, leaving only one edge joining or electrically connecting the two metal layers (ML-1, ML-2).

In the above-described manner, a single sheet of metal may be folded upon itself (with an insulating layer, such as adhesive therebetween) to form a two metal layer construction for a card body (CB) of an RFID device such as a proximity card (PC) or a smartcard (SC). Notice that only one of the layers (formed by the two side portions) will have a slit, which is well supported by the other layer (formed by the middle portion). Optionally, a slit may also be formed in the middle portion, and should be offset from the slit formed by the two folded-over side portions.

FIG. 7A shows a front surface of a metal layer double (twice) the size of an ID-1 card body (OML 722) with two fold lines (FL 780) and a cut-out (half sized opening) (MO 708) located at the top and bottom edge (left hand side) of the metal layer (OML 722) which is later folded on itself along both fold lines to form an ID-1 size card body. In this illustration, there is an opening (MO 708) in the center area of the non-folded metal layer, but may be omitted in another configuration.
722 Oversized metal layer (OML)
708 module opening (MO) to accept an RFID chip module (CM)
780 fold line (FL)

FIG. 7B shows an ID-1 metal card body (FML 724) with two metal edge folds (FL 780) having a cut-out on each fold which meet in the center of the card body to form an opening (MO 708) on the left hand side of the card body and a slit or gap (S 730 and G 790) which runs along the perimeter edges (G) and along the center position (S) of the fold. In addition, a detailed view of the slit or gap running along the folded perimeter metal edge of the card body and a detailed view of the slit or gap running along the perimeter edge of the folds and passing through the center of the opening are provided.

Although the slit or gap is continuous as a result of the folded metal edges meeting in the center of the card body, it is feasible to electrically connect both folds at a point along the continuous slit or gap to concentrate surface currents.
724 folder metal layer (FML)
708 module opening (MO) to accept an RFID chip module (CM)
730 slit (S)
780 fold line (FL)
790 slit or gap (G)

The slit S 730 and the gap G 790 represent metal edges in which surface current flow.

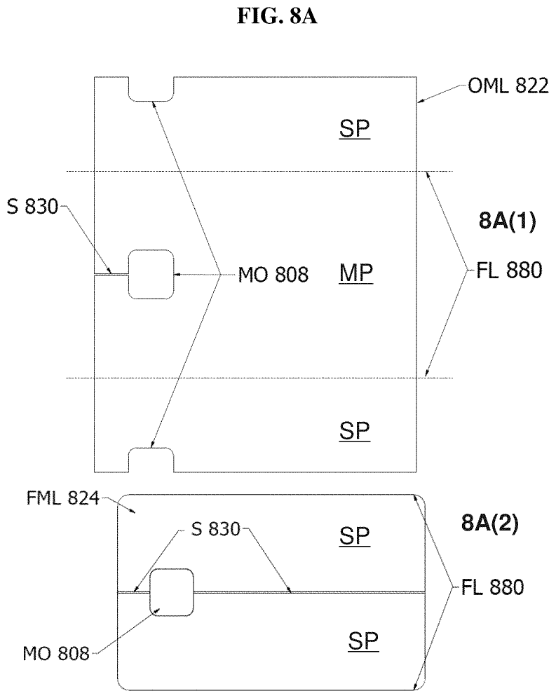

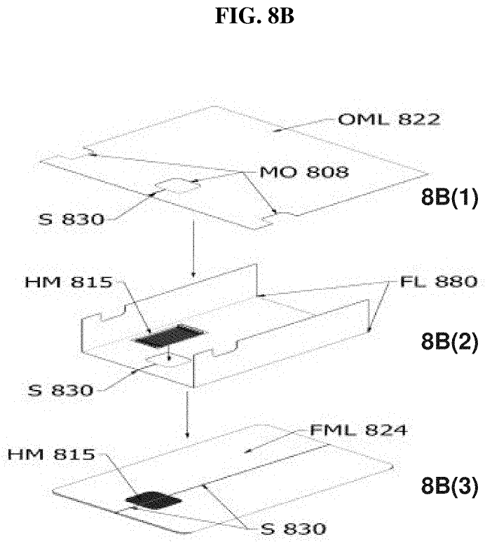

FIG. 8A is similar to FIG. 7A, but the middle panel (MP) is provided with a slit (S).

FIG. 8A shows a front surface of a metal layer double the size of an ID-1 card body (OML 822) with two fold lines (FL 880), a cut-out (half sized opening) (MO 808) located at the top and bottom edge (left hand side) of the metal layer and a complete opening (MO 808) in the vertical center of the metal layer with a slit (S 830) which commences at a perimeter edge of the metal layer and enters the opening (MO 808). The metal layer (OML 822) with cut-outs, opening and slit is later folded on itself along both fold lines to form an ID-1 size card body.
822 oversized metal layer (OML)
824 folded metal layer (FML)
808 module opening (MO) to accept an RFID chip module (CM)
830 slit (S)
880 fold line (FL)

The gap G at the perimeter edge of the card body is not visible in this perspective view.
The upper diagram 8A(1) shows the oversize metal layer, before folding.
The lower diagram 8A(2) shows the oversize metal layer, after folding.

FIG. 8B shows a top view of an oversized metal layer (OML 822) to form a folded ID-1 card body with two folds (FL 880) with each having a cut-out portion of an opening, a full size opening (MO 808) in the unfolded metal layer which later is concentric with the cut-out openings on the two folded wings of the metal layer. A slit (S 830) commences at the perimeter edge of the unfolded section of the metal layer and enters the opening in said unfolded section. In addition, a top view of a folded ID-1 metal card body is provided showing an opening on the left hand side through the card body and a slit which runs along the perimeter edges and along the center position of the fold.
822 oversized metal layer (OML)
824 folded metal layer (FML)
808 module opening (MO) to accept an RFID chip module (CM)
815 RFID chip module (CM) with a helix antenna structure aka helix module (HM)
830 slit (S)
880 fold line (FL)
The upper diagram 8B(1) shows the oversize metal layer (OML), before folding.
The middle diagram 8B(2) shows the oversize metal layer (OML), with the sides (SP) partially folded (up).
The lower diagram 8B(3) shows the oversize metal layer (OML), with the sides (SP) fully folded, over and down onto the middle portion
   Card with Booster Antenna

FIG. 9A shows a booster antenna (BA) having a card antenna CA, a coupler coil CC and an extension antenna (EA). These components may be formed (embedded in the card body CB) as one continuous embedded coil. The coupler coil CC is in the form of an open loop (“horseshoe”).

Note that both of the outer winding OW and inner winding IW are enlarged to form the coupler coil CC and substantially fully encircle the antenna module AM in the coupling area (144). The free ends (a, f) of the card antenna CA are shown disposed at the right edge of the card body CB.

The extension antenna EA has one end extending from an end of the coupler coil CC, and another end extending from an end of the card antenna CA, and exhibits a cross-over. The extension antenna EA (or extension coil, or extension loop) is disposed so as to have a portion adjacent two sides (or approximately 180°) of the coupler coil CC.

An antenna extension EA component is shown as an “extension” of the inner winding IW, comprising some turns of wire in a spiral pattern disposed near the antenna module AM in the left hand side of the top (as viewed) portion (120a) of the card body CB. The extension antenna EA may be disposed outside of, but near the coupling area (144) of the card body CB, in the residual area (148).

In this example, the coupler coil CC component of the booster antenna BA does not need to be a “true” coil, it does not need to have a cross-over. Rather, it may be a horseshoe-shaped “open” loop which substantially fully, but less than 360°, encircles the coupling area (144) for inductive coupling with the module antenna MA of the antenna module AM.

In this example, the card antenna CA is a true coil, in the form of a spiral extending around the peripheral area (142) of the card body CB, and exhibits a cross-over.

The extension antenna (or extension coil) EA has two ends—one end is connected to the coupler coil CC, the other end is connected to the card antenna CA. The extension antenna EA may be formed as a spiral of wire embedded in the card body CB, contiguous with one or more of the card antenna CA and coupler coil CC, and is a true coil which exhibits a cross-over, and contributes to the inductive coupling of the booster antenna BA. The extension antenna EA may be disposed in the residual area (148) of the card body CB, and is shown as being disposed only in the upper half (120a) of the card body CB, but it may extend to the lower half (120b) of the card body CB, including any or all of adjacent to, above, below or into the embossing area (146).

FIG. 9B shows a booster antenna BA having a card antenna CA, a coupler coil CC and an extension antenna EA. These components may be formed (embedded in the card body CB) as one continuous embedded coil. The coupler coil CC is in the form of a closed loop, having a cross-over.

The extension antenna EA (or extension coil, or extension loop) has one end extending from an end of the coupler coil CC, and another end extending from an end of the card antenna CA, and exhibits a cross-over. The extension antenna EA is disposed so as to have a portion adjacent two sides (or approximately 180°) of the coupler coil CC.

In this example, the layout of the inner windings (IW) and outer windings (OW) of the card antenna CA are slightly different than in FIG. 9A. The inner windings IW of the card antenna CA pass over the extension antenna EA at a different location than in FIG. 9A. In this example, the coupler coil CC forms a closed loop (rather than the horseshoe shown in FIG. 9A) around the antenna module AM, has a cross-over, and may therefore may be considered to be a “true” coil.

In this example, the extension coil EA is a true coil having a cross-over, is disposed in the residual area (148) of the card body CB, and is shown as being disposed only in the upper half (120a) of the card body CB, but it may extend to the lower half (120b) of the card body CB and into the embossing area (146). In this example, the extension antenna (EA) may occupy a larger area and have a narrower pitch (closer spacing of windings) than the extension antenna EA of FIG. 9A.

A benefit of having the extension antenna EA in a booster antenna BA may be to increase the inductivity of the booster antenna BA while reducing its resonance frequency. For example, without the extension antenna EA, the card antenna CA may require significantly more windings (such as in excess of 15 windings, instead of only 7 or 8 windings), depending on the spacing between the windings and the diameter or cross sectional area of the conductor of the wire used to form the booster antenna BA. It is within the scope of the invention that the card antenna CA has only one winding.

The booster antennas (BA) of FIGS. 9A and 9B both show card antennas CA having an inner winding (IW) and an outer winding (OW).

Card with Coupling Frame Antenna

US 2018/0341847 discloses SMARTCARD WITH COUPLING FRAME ANTENNA, and describes a smartcard (SC) having a card body (CB) and a conductive coupling frame antenna (CFA) extending as a closed loop circuit around a periphery of the card body, and also extending inwardly so that two portions of the coupling frame antenna are closely adjacent each other, with a gap therebetween.

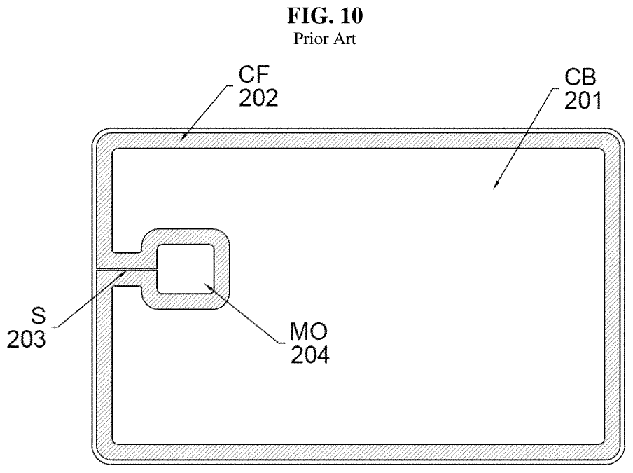

FIG. 10 shows an exemplary coupling frame antenna (CFA) with a track width of approximately 3 mm. The design shown illustrates a continuous closed loop single track coupling frame antenna (CFA) 202 placed within the perimeter defined by the card body (CB) 201. It is noted that the figure is illustrative of the shape and overall form of the coupling frame antenna (CFA) 202 and that the antenna may reside upon or between any of the layers that may make up a typical smartcard. The outer edges of the coupling frame antenna (CFA) 402 may extend to the periphery of the card body (CB) 201 or be offset from the edge of the smartcard by some distance to aid lamination or other assembly of the smartcard's additional layers. The path defined by the coupling frame antenna (CFA) 201 extends inwards towards and around the module opening (MO) 204. The length, width and track thickness of the coupling frame antenna (CFA) 202 in the vicinity of the module opening (MO) 204 may be set as to provide an optimum overlap with the module antenna (MA) of the transponder chip module (TCM).

The shape of the coupling frame antenna, as it extends inwardly from the left (as viewed) side of the card body to the module opening area, results in two side-by-side portions of the coupling frame antenna (CFA) being closely adjacent each other, with a gap therebetween. This gap may be comparable to the slit (S) in a conventional coupling frame (CF)

Generally, a “coupling frame” (CF) may comprise a metal layer, metal frame, metal plate or any electrically-conductive medium or surface with an electrical discontinuity such as in the form of a slit (S) or a non-conductive stripe extending from an outer edge of the layer to an inner position thereof, the coupling frame (CF) capable of being oriented so that the slit (S) overlaps (crosses-over) the module antenna (MA) of the transponder chip module (TCM), such as on at least one side thereof. The slit (S) may be straight, and may have a width and a length. In some embodiments, the slit (S) may extend to an opening (MO) for accepting the transponder chip module. In other embodiments, there may only be a slit, and no opening for the transponder chip module (TCM). Coupling frames of this type, typically a layer of metal with an opening for receiving a transponder chip module, and a slit extending from a periphery of the layer to the opening, wherein the slit overlaps at least a portion of the module antenna, may be found in U.S. Pat. Nos. 9,812,782, 9,390,364, 9,634,391, 9,798,968, and 9,475,086.

In contrast thereto, the coupling frame antenna (CFA) of the present invention may comprise a continuous conductive path or a track of wire or foil formed around the transponder chip module (TCM), such as by embedding wire or by etching a conductive path or track in the form of a one turn (or single-loop) antenna. The coupling frame may be planar or three dimensional (such as a curved surface). The coupling frame for inductive coupling with a reader may couple with either a passive or an active transponder chip module.

The path (or track) of the single-loop coupling frame antenna (CFA) may generally be around the periphery of the card body, but may extend to an inner position of the card body and double back on itself at selected areas of the card body, leaving a gap or void between the adjacent portions of the track. The space (void, gap) between closely-adjacent portions of the single-loop coupling frame may perform the function of a slit (S) in a conventional coupling frame—namely, overlap a portion of a module antenna in the transponder chip module—but it is distinctly different in construction. The coupling frame antenna (CFA) may wrap around the position (or module opening MO) for the transponder chip module (TCM).

Generally, the term “slit” will be applied to coupling frames (CF), and the term “space” will be applied to the corresponding feature of coupling frame antennas (CFA). However, in some instances, the term “slit” may be used to describe the space (void, gap) between closely-adjacent portions of the single-loop coupling frame antenna (CFA).

The overlap of the slit (or space) of either a coupling frame (CF) or a coupling frame antenna (CFA) with the module antenna (MA) may be less than 100%. In addition, the width and length of the slit (or space) can significantly affect the resonance frequency of the system and may be used as a tuning mechanism. As the width of slit (or space) changes, there is a resulting change in the overlap of the slit with the antenna.

Another distinction is important. When referring to a conventional overall coupling frame (CF) as being “continuous”, it should be understood that the slit (S) represents both a mechanical and an electrical discontinuity in an otherwise continuous (electrically and mechanically) structure. The slit is a feature extending from an edge of the coupling frame (CF) to an interior position thereof (typically, the module opening for the transponder chip module).

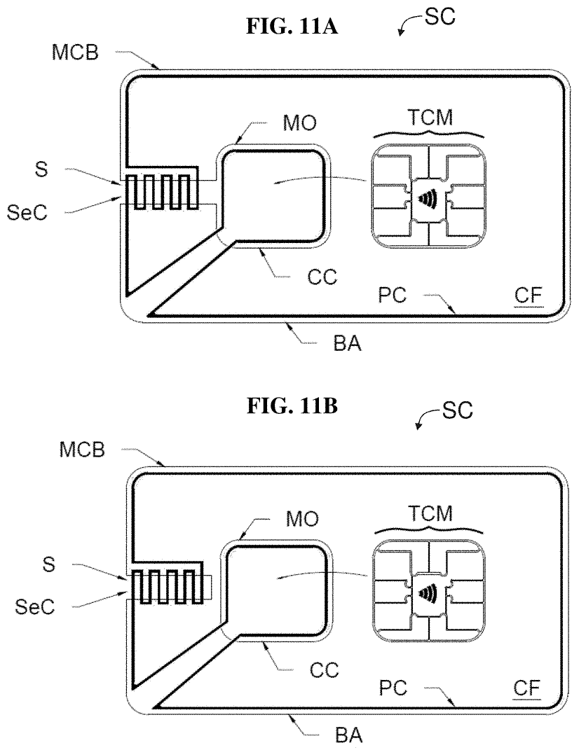

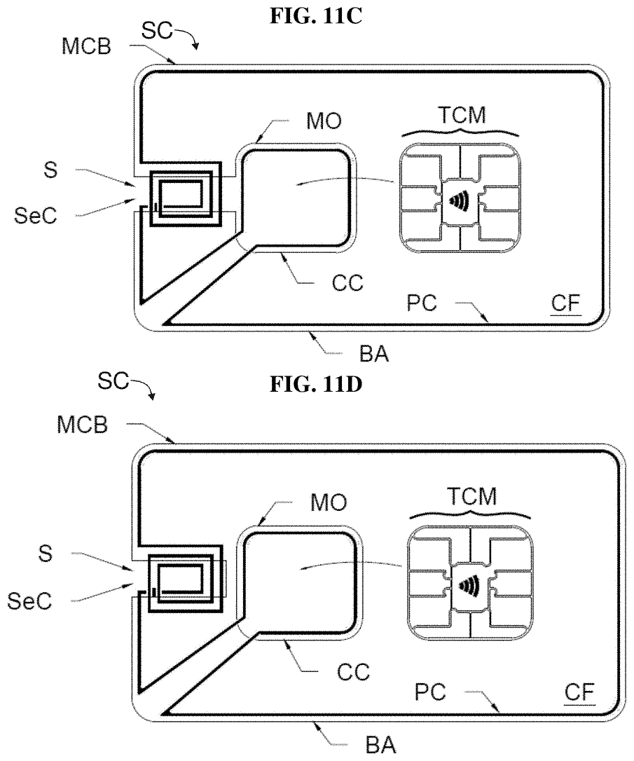

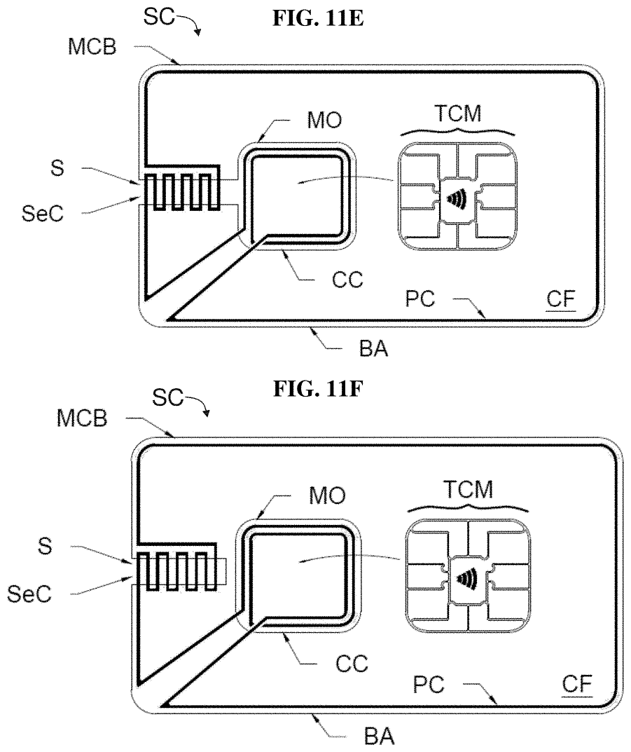

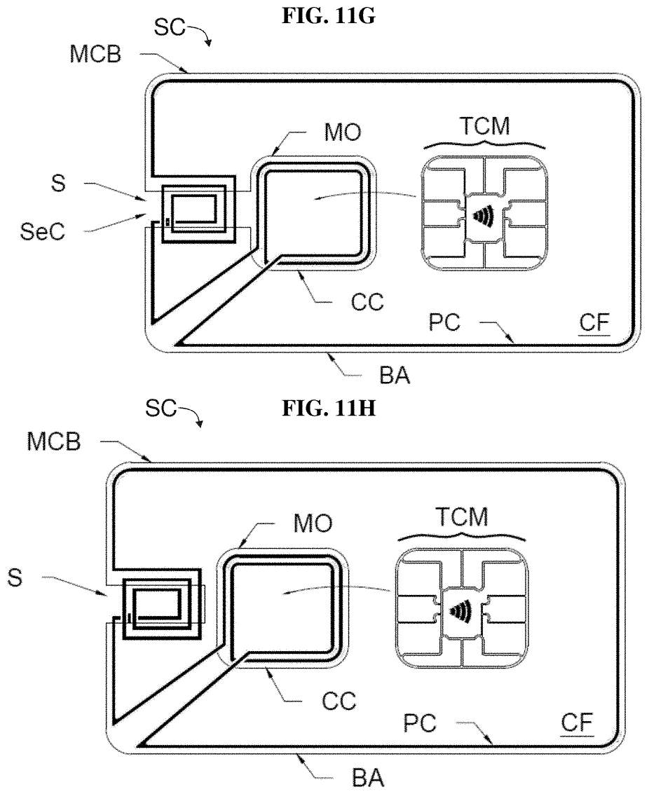

### FIGS. 11-15

Some embodiments of smartcards having coupling frames and booster antennas will now be described.

A smartcard (SC) has a metal card body (MCB) with an opening (MO) for a transponder chip module (TCM) and a slit (S). The metal card body may function as a coupling frame (CF). See, e.g., U.S. Pat. Nos. 9,475,086, 9,798,968.

Regarding the slit . . .
The slit may extend from an outer edge of the metal card body to the module opening.
The slit may extend from the outer edge of the metal card body, partially to the module opening.
The slit may extend from the module opening, partially to the outer edge of the metal card body.

A booster antenna (BA) is provided, and may comprise of a wire embedded antenna ultrasonically scribed into a plastic layer (PL). The booster antenna may have three portions, or components:
a perimeter coil (PC) component extending around a peripheral area of the card body, and having one or more turns;
a coupling or coupler coil (CC) component located at the module opening for coupling with a module antenna (MA) in the transponder chip module (TCM), and having one or more turns;
a sense coil (SeC) component located at the slit, and may overlap or overly the slit, typically in a zigzag fashion or the like. The sense coil could have a loop, spiral or helix shape.

The booster antenna may form a closed loop, and may have no free ends.

The sense coil (acting like a pick-up coil) interacts/couples with the coupling frame, at the location of the slit, and may be configured with different patterns, as follows:
the sense coil may be embedded wire, and may traverse the slit a number of times, generally perpendicular to the slit, including an area outside of the slit.
the sense coil may be embedded wire, and may zigzag, extending generally parallel to the slit, including an area outside of the slit.
the sense coil may be embedded wire in the form of a spiral, or the like, overlapping or overlying the slit.
the sense coil may be in the form of a conductive track, or “ribbon”, such as in US 2018/0341847, and may extend parallel inward, cross the slit, and extend parallel outward, including overlapping or overlying an area outside of the slit.

Ferrite may be disposed between the plastic layer and coupling frame, but may be disposed only within (an interior area of) the booster antenna, such as on the plastic layer (PL) in areas not occupied by the booster antenna. This may be referred to as ferrite disposed between the booster antenna and the coupling frame.

Booster Antenna Coupling with RFID Slit Technology

Contactless cards operating in contactless mode including dual interface (contact and contactless) smartcards may have a coupling frame (CF) and a booster antenna (BA) arranged in a metal card body (MCB) to interact with each other to allow for enhanced contactless communication.

FIG. 11A shows a metal card body (MCB) and a booster antenna (BA) in a smartcard (SC), according to an embodiment of the invention. A sense coil (SeC) has an interdigitated or zigzag form with multiple turns and overlaps or overlies the slit (S) which extends to the module opening (MO). The sense coil (SeC) as part of the perimeter coil (PC) drives the module antenna (MA) of the transponder chip module (TCM) by means of a single loop coupler coil (CC).

FIG. 11B shows a modification of the metal card body of FIG. 3A in which the slit (S) does not extend to the module opening (MO).

FIG. 11C shows a metal card body (MCB) and a booster antenna (BA) in a smartcard (SC), according to an embodiment of the invention. A sense coil (SeC) has a loop or spiral form with multiple turns and overlaps or overlies the slit (S) which extends to the module opening (MO). The sense coil (SeC) as part of the perimeter coil (PC) drives the module antenna (MA) of the transponder chip module (TCM) by means of a single loop coupler coil (CC).

FIG. 11D shows a modification of the metal card body of FIG. 3C in which the slit (S) does not extend to the module opening (MO).

FIG. 11E shows a metal card body (MCB) and a booster antenna (BA) in a smartcard (SC), according to an embodiment of the invention. A sense coil (SeC) has an interdigitated or zigzag form with multiple turns and overlaps or overlies the slit (S) which extends to the module opening (MO). The sense coil (SeC) as part of the perimeter coil (PC) drives the module antenna (MA) of the transponder chip module (TCM) by means of a multiple loop coupler coil (CC).

FIG. 11F shows a modification of the metal card body of FIG. 3E in which the slit (S) does not extend to the module opening (MO).

FIG. 11G shows a metal card body (MCB) and a booster antenna (BA) in a smartcard (SC), according to an embodiment of the invention. A sense coil (SeC) has a loop or spiral form with multiple turns and overlaps or overlies the slit (S) which extends to the module opening (MO). The sense coil (SeC) as part of the perimeter coil (PC) drives the module antenna (MA) of the transponder chip module (TCM) by means of a multiple loop coupler coil (CC).

FIG. 11H shows a modification of the metal card body of FIG. 3G in which the slit (S) does not extend to the module opening (MO).

For the purpose of clarity, the sense coil (SeC) may overlap or overlie a slit in a metal layer (ML) or metal card body (MCB), but equally the sense coil (SeC) may be integrated or positioned within the slit collecting surface currents from within the slit and or at the metal edges.

FIG. 12A shows a metal card body (MCB) and a booster antenna (BA) in a smartcard (SC), according to an embodiment of the invention. A sense coil (SeC) crosses over the slit (S) several times, perpendicular to and overlapping the slit.

FIG. 12B shows a metal card body (MCB) and a booster antenna (BA) in a smartcard (SC), according to an embodiment of the invention. A sense coil (SeC) traverses back and forth (meanders) in the slit, parallel to the slit, and may overlap the slit.

FIG. 12C shows a metal card body (MCB) and a booster antenna (BA) in a smartcard (SC), according to an embodiment of the invention. The sense coil (SeC) as part of the perimeter coil (PC) is like a ribbon, running along the edge of the card body, then traverses the slit (perpendicular thereto), and continuous to run parallel to the edge of the card body. The slit does not extend to the module opening (MO).

FIG. 13A shows a metal card body (MCB) and a booster antenna (BA) in a smartcard (SC), according to an embodiment of the invention. The sense coil traverses back and forth (meanders) in the slit (S₁), parallel, and may overlap the slit. The slit (S₁) extends to the module opening (MO). The coupler coil (CC) is a loop antenna with multiple turns which couples with the module antenna (MA) of the transponder chip module (TCM). The second slit (S₂) is a wide gap and the perimeter coil wraps around the slit (S₂).

FIG. 13B shows a modification of the metal card body of FIG. 5A in which the perimeter coil (PC) forms a meander around and within the area of the second slit (S₂).

FIG. 13C shows a metal card body (MCB) and a booster antenna (BA) in a smartcard (SC), according to an embodiment of the invention. The sense coil traverses back and forth (meanders) in the slit (S₁), parallel, and may overlap the slit. The slit (S₁) extends to the module opening (MO). The coupler coil (CC) is a loop antenna with multiple turns which couples with the module antenna (MA) of the transponder chip module (TCM). The second slit (S₂) is a wide gap and the perimeter coil is arranged within the area of the slit (S₂) for optimum performance. The distribution of surface currents is collected at both slits (S₁ and S₂).

FIG. 13D shows a modification of the metal card body of FIG. 5C in which the perimeter coil (PC) is arranged outside the area of the second slit (S₂).

In the drawings, the direction of the windings or turns of the sense coil (SeC) across the slit (S) is portrayed in a perpendicular and parallel manner, but as discussed above, the direction and shape of the coil (SeC) may be a combination of perpendicular and parallel windings, to optimize the self-inductance and minimize the negative mutual inductance which results in current cancellations. Further, the sense coil (SeC) can meander around or within the area of the slit or slits. The sense coil (SeC) may be part of a wire embedded booster antenna (BA) or the sense coil (SeC) may be on a flexible circuit assembled to the metal card body. An anti-shielding material such as ferrite, not shown, may be incorporated in the card construction. An air gap may exist between the metal layer (ML) acting as coupling frame and the booster antenna (BA).

In all the schematics presented in which the coupler coil (CC) of the booster antenna (BA) inductively couples with the module antenna (MA) of the transponder chip module (TCM) while the other component elements of the booster antenna (BA) in the particular the perimeter coil (PC) and the sense coil (SeC) harvest energy by picking up surface currents around the area of the slit and the metal card body (MCB), it is feasible to eliminate the coupler coil (CC) and make a direct connection from the perimeter coil (PC) to the RFID chip assembled to the chip module (CM), eliminating also the need for a module antenna (MA) on the face-down side of the chip module (CM). This complicates the manufacturing process as the wire ends of the perimeter coil (PC) would have to be physically connected to the chip module (CM), but it represents a viable alternative which could be cost effective.

In addition, an extension antenna (EA) may be used to tune the booster antenna or potentially drive an electronic component.

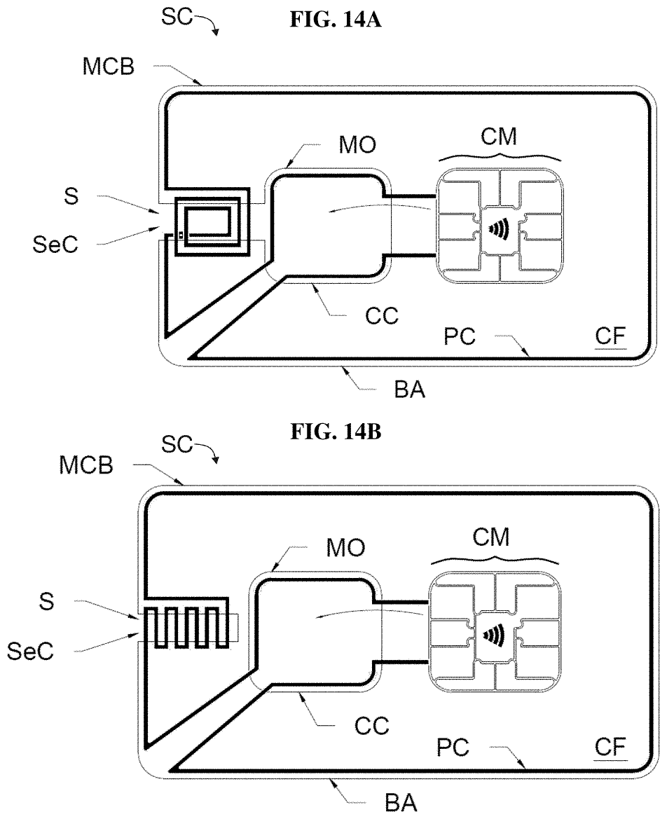

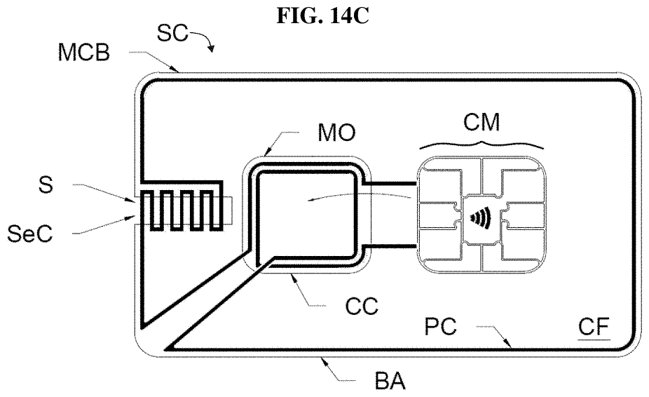

FIG. 14A shows a metal card body (MCB) and a booster antenna (BA) in a smartcard (SC), according to an embodiment of the invention. A sense coil (SeC) has a loop or spiral form with multiple turns and overlaps the slit (S) which extends to the module opening (MO). The wire ends of the perimeter coil (PC) are galvanically connected to the chip module (CM), eliminating the need for a coupler coil in the booster antenna and a module antenna in the transponder chip module.

FIG. 14B shows a modification of the metal card body of FIG. 6A in which the slit (S) does not extend to the module opening (MO), and the sense coil (SeC) has an interdigitated or zigzag form instead of a loop form with the wire ends of the perimeter coil (PC) connected directly to the chip module (CM).

FIG. 14C shows a metal card body (MCB) and a booster antenna (BA) in a smartcard (SC), according to an embodiment of the invention. A sense coil (SeC) has an interdigitated or zigzag form with multiple turns and overlaps the slit (S) which does not extend to the module opening (MO). The sense coil (SeC) and the perimeter coil (PC) connected to a multiple loop coupler coil (CC) pick up current flows around the slit and module opening (MO) and direct them to the chip module (CM). The wire ends of the multiple turn coupler coil which overlaps or is adjacent to the module opening (MO) is galvanically connected to the chip module (CM).

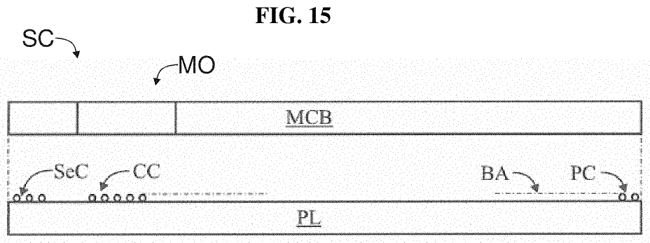

FIG. 15 shows a metal card body (MCB) and a booster antenna (BA) in a smartcard (SC), according to an embodiment of the invention. The metal card body (MCB) may have a module opening (MO) for a transponder chip module (TCM, not shown), and a slit (S, not shown) extending from an edge of the card body to an interior position of the card body, including to the module opening. The booster antenna (BA) and perimeter coil (PC) may be mounted on plastic layer (PL).

### CNC Milling

Typically, cards may be manufactured (laid up and laminated) in sheet form, each sheet having a plurality of cards, such as in a 5×5 array, and CNC (computer numerical control) machining may be used to singulate (separate) the finished cards from the sheet. Resulting burrs, particularly in the metal layers, may cause defects, such as electrical shorting of the slit. Hence, CNC machining of metal core, metal face or solid metal smartcards may be performed using cryogenic milling, such as in an environment of frozen carbon dioxide or liquid nitrogen.

### Some Additional Comments

Some of the card embodiments disclosed herein may have two metal layers, separated by a dielectric coating or an insulating layer, rather than a single metal layer. The two metal layers may comprise different materials and may have different thicknesses than one another. For example, one of the metal layer may be stainless steel while the other metal layer may be titanium. In this manner, the “drop acoustics” of the metal card body may be improved, in that the card, when dropped or tapped (edgewise) on a hard surface, sounds like a solid metal card (making a ringing or tinkling sound), rather than like a plastic card (making a “thud”).

Generally, in order for the smartcard to be “RFID-enabled” (able to interact “contactlessly”), each of the one or more metal layers should have a slit, or micro-slit. When there are two (or more) metal layers with slits in the stack-up, the slits in the metal layers should be offset from one another.

### Some Generic Characteristics

The smartcards described herein may have the following generic characteristics:
The card body may have dimensions similar to those of a credit card. ID-1 of the ISO/IEC 7810 standard defines cards as generally rectangular, measuring nominally 85.60 by 53.98 millimeters (3.37 in×2.13 in).
A chip module (RFID, contact type, or dual interface) may be implanted in a recess (cavity, opening) in the card body. The recess may be a stepped recess having a first (upper, P1 portion) having a cavity depth of 250 μm, and a second (lower, P2 portion) having a cavity depth of (maximum) 600 μm.
A contact-only or dual interface chip module will have contact pads exposed at a front surface of the card body.
ISO 7816 specifies minimum and maximum thickness dimensions of a card body:
   Min 0.68 mm (680 μm) to Max 0.84 mm (840 μm) or Min 0.027 inch to Max 0.033 inch

Generally, any dimensions set forth herein are approximate, and materials set forth herein are intended to be exemplary. Conventional abbreviations such as “cm” for centimeter”, “mm” for millimeter, “μm” for micron, and “nm” for nanometer may be used.

The concept of modifying a metal element of an RFID-enabled device such as a smartcard to have a slit (S) to function as a coupling frame (CF) may be applied to other products which may have an antenna module (AM) or transponder chip module (TCM) integrated therewith, such as watches, wearable devices, and the like.

Some of the features of some of the embodiments of RFID-enabled smartcards may be applicable to other RFID-enabled devices, such as smartcards having a different form factor (e.g., size), ID-000 (“mini-SIM” format of subscriber identity modules), keyfobs, payment objects, and non-secure NFC/RFID devices in any form factor

The RFID-enabled cards (and other devices) disclosed herein may be passive devices, not having a battery and harvesting power from an external contactless reader (ISO 14443). However, some of the teachings presented herein may find applicability with cards having self-contained power sources, such as small batteries (lithium-ion batteries with high areal capacity electrodes) or supercapacitors.

The transponder chip modules (TCM) disclosed herein may be contactless only, or dual-interface (contact and contactless) modules.

In their various embodiments, the invention(s) described herein may relate to payment smartcards (metal, plastic or a combination thereof), electronic credentials, identity cards, loyalty cards, access control cards, and the like.

While the invention(s) may have been described with respect to a limited number of embodiments, these should not be construed as limitations on the scope of the invention(s), but rather as examples of some of the embodiments of the invention(s). Those skilled in the art may envision other possible variations, modifications, and implementations that are also within the scope of the invention(s), and claims, based on the disclosure(s) set forth herein.

What is claimed is:

1. A method of making a card body (CB) for an RFID device of a given size, comprising:
providing an oversize metal layer (OML) having a full size middle portion (MP) flanked by two half size side portions (SP) extending from opposite side edges of the middle portion; and
folding the two side portions, towards each other, over the middle portion so that their outer edges (oe) oppose and nearly touch each other, leaving a slit (S) therebetween.

2. The method of claim 1, further comprising:
providing an insulating layer between the middle portion and the side portions.

3. The method of claim 1, further comprising:
providing a full size module opening (fMO) in the middle portion; and
providing a half size module opening (hMO) in each of the side portions.

4. The method of claim 3, wherein:
when the side portions are folded over the middle portion, the half size module openings oppose each other, and together form a full size module opening.

5. The method of claim 1, further comprising:
providing a slit (S) in the middle portion.

6. The method of claim 1, further comprising:
after folding, trimming one of the outer edges.

7. The method of claim 1, wherein:
the RFID device is a smartcard (SC) or a proximity card (PC).

8. The method of claim 1, wherein:
the middle portion represents a first metal layer (ML-1);
the folded over side portions represent a second metal layer (ML-2); and
further comprising disposing an RFID chip module between the two metal layers.

9. The method of claim 8, wherein:
both metal layers have a slot to accept a lanyard.

10. The method of claim 8, further comprising:
providing an antenna structure which is adjacent to or overlaps the slit.

11. A smartcard comprising:
a coupling frame (CF) comprising a metal layer (ML) with a slit (S); and
a booster antenna (BA).

12. The smartcard of claim 11, wherein:
the booster antenna comprises a sense coil (SeC) disposed in, or across, or overlapping the slit, including an area adjacent to the slit.

13. The smartcard of claim 11, further comprising:
ferrite disposed between the booster antenna and the coupling frame.

14. The smartcard of claim 11, wherein:
the smartcard is a contactless smartcard, or is a dual interface (contactless and contact) smartcard.

15. The smartcard of claim 11, wherein the booster antenna comprises:
a perimeter coil (PC) component extending around a peripheral area of the card body, and having one or more turns;
a coupling or coupler coil (CC) component located at the module opening for coupling with an antenna (MA) in the transponder chip module, and having one or more turns; and
a sense coil (SeC) component located at an area of the slit.

16. The smartcard of claim 15, wherein:
the sense coil has a zigzag, loop, helical or spiral shape.

17. The smartcard of claim 15, wherein:
the sense coil crosses over the slit several times, perpendicular to and overlapping the slit.

18. The smartcard of claim 15, wherein:
the sense coil traverses back and forth (meanders) in the slit, parallel to the slit.

19. The smartcard of claim 15, wherein:
the sense coil (acting like a pickup coil) interacts/couples with the coupling frame, at the location of the slit, and comprises one or more of the following:
the sense coil comprises embedded wire, and traverses the slit a number of times, generally perpendicular to the slit, including an area outside of the slit;
the sense coil comprises embedded wire, and zigzags, extending generally parallel to the slit, including an area outside of the slit;
the sense coil comprises embedded wire in the form of a spiral, or the like, overlapping the slit; and
the sense coil comprises a conductive track, or “ribbon”, such as in US 2018/0341847, and extends parallel inward, cross the slit, and extend parallel outward, including overlapping an area outside of the slit.

20. The smartcard of claim 11, wherein:
the booster antenna comprises wire embedded in a plastic layer (PL); and
further comprising ferrite disposed between the plastic layer and the coupling frame.
